(19) United States
(12) Patent Application Publication
(10) Pub. No.: US 2012/0328050 A1
(43) Pub. Date: Dec. 27, 2012

(54) CENTRALIZED ADAPTOR ARCHITECTURE FOR POWER AMPLIFIER LINEARIZATIONS IN ADVANCED WIRELESS COMMUNICATION SYSTEMS

(75) Inventors: Chunlong Bai, Kanata (CA); Russell Smiley, Richmond (CA)

(73) Assignee: TELEFONAKTIEBOLAGET L M ERICSSON (PUBL), Stockholm (SE)

(21) Appl. No.: 13/164,816

(22) Filed: Jun. 21, 2011

(51) Int. Cl. H04L 25/49; H04B 1/04

(52) U.S. Cl. 375/297; 455/114.3

(57) ABSTRACT

Embodiments of a centralized predistortion system and corresponding adaptive predistortion processes are disclosed. In general, a central node includes one or more centralized predistortion components that enable predistortion for one or more remote transmit chains in order to compensate for non-linearity of power amplifiers in the one or more remote transmit chains. For instance, in one embodiment, the central node is a hub base station and the one or more remote transmit chains are included in one or more transmitters at one or more satellite base stations.

### FIELD OF THE DISCLOSURE

The present disclosure relates to power amplifier linearization and more particularly relates to a centralized architecture for power amplifier linearization.

### BACKGROUND

A radio system generally includes a transmitter that transmits information-carrying signals to a receiver. The transmitter includes a power amplifier that operates to amplify the signal to be transmitted to a power level that is sufficient to enable receipt of the signal by the receiver. Radio system transmitters are required to satisfy specifications for signal levels at frequencies other than the intended transmission frequencies. Some specifications are set by government regulatory bodies, while others are set by radio communications standards such as 3GPP or IEEE 802.11. One specification, or requirement, is adjacent channel power, which is directly related to power amplifier linearity. Power amplifier linearity corresponds to an ability to reproduce an amplified version of the input signal. Also, power amplifiers are often described in terms of their efficiency, which is defined as some comparison between average transmit signal power and total average power required to generate the transmit signal power.

At a circuit level, power amplifier linearity may be achieved by biasing transistors in such a manner that the power amplifier operates in a linear fashion. However, doing so has a cost in terms of very low operating efficiency. As such, many modern power amplifiers are configured to operate at maximum efficiency, resulting in poor linearity, and use so-called “linearization” circuitry to correct non-linearity. Some exemplary power amplifiers that have high efficiency, but low linearity, are Class AB power amplifiers, Class B power amplifiers, Class C power amplifiers, Class F power amplifiers, Doherty power amplifiers, and Chireix power amplifiers.

Various linearization schemes have evolved having various trade-offs in terms of linearity, power dissipation, and versatility or robustness. These linearization schemes include, but are not limited to, analog predistortion, digital predistortion, feed-forward linearization, and feedback linearization. Predistortion linearization uses a predefined model of power amplifier non-linearity to generate an “opposite” nonlinear response that compensates for the non-linearity of the power amplifier. By amplifying the predistorted signal, the output of the power amplifier is as if the power amplifier were linear.

Qualities of the hardware used to construct a transmitter, and particularly the power amplifier, may change over time. As a result, over time, the model of the non-linearity of the power amplifier may gradually increase in error. In order to address this issue, adaptive predistortion schemes are utilized to compensate for changes in the non-linearity of the power amplifier over time. In these adaptive predistortion schemes, a result of the linearization, i.e., the output of the power amplifier, is monitored, and the predistortion is updated to reflect changes in the non-linearity of the power amplifier.

Linearization circuitry, such as predistortion circuitry, necessarily consumes power. Typically, a compromise between linearity, efficiency, and complexity must be made for each particular application. For conventional adaptive predistortion architectures, the power consumption of the adaptive predistortion circuitry is independent of power amplifier transmit level. As such, overhead for adaptive predistortion circuitry is negligible for high power applications. However, for low power applications such as many emerging cellular networks, the overhead of the conventional adaptive predistortion circuitry becomes significant. In fact, the cost of the adaptive predistortion circuitry in terms of power consumption may start to outweigh the benefits of the adaptive predistortion circuitry in terms of linearity. Thus, there is a need for an adaptive predistortion architecture that reduces power consumption particularly for low power applications.

### SUMMARY

Embodiments of a centralized predistortion system and corresponding adaptive predistortion processes are disclosed. In general, a central node includes one or more centralized predistortion components that enable predistortion for one or more remote transmit chains in order to compensate for non-linearity of power amplifiers in the one or more remote transmit chains. For instance, in one embodiment, the central node is a hub base station and the one or more remote transmit chains are included in one or more transmitters at one or more satellite base stations.

In one embodiment, the one or more centralized predistortion components include individual adaptors for the one or more remote transmit chains. Each individual adaptor evaluates a set of predistortion parameters that define a predistortion to be applied to a data signal to be transmitted by a corresponding remote transmit chain in order to compensate for a non-linearity of the power amplifier in the remote transmit chain. The central node then provides the set of predistortion parameters evaluated by the individual adaptor to the corresponding remote transmit chain for utilization by the remote transmit chain to predistort the data signal to be transmitted by the remote transmit chain in order to compensate for the non-linearity of the power amplifier in the remote transmit chain.

In another embodiment, the one or more centralized predistortion components include individual adaptors and individual predistorters for the one or more remote transmit chains. Each remote transmit chain has a corresponding individual adaptor and a corresponding individual predistorter. The individual adaptor for a remote transmit chain evaluates a set of predistortion parameters that define a predistortion to be applied to a data signal to be transmitted by the remote transmit chain in order to compensate for a non-linearity of the power amplifier in the remote transmit chain. The predistorter for the remote transmit chain predistorts the data signal to be transmitted by the remote transmit chain based on the set of predistortion parameters evaluated by the individual adaptor for the remote transmit chain to thereby provide a predistorted data signal. The central node then provides the predistorted data signal generated by the individual predistorter to the corresponding remote transmit chain for amplification and transmission.

In another embodiment, the one or more remote transmit chains include multiple remote transmit chains, and the one or more centralized predistortion components include a shared adaptor for the multiple remote transmit chains. The shared adaptor is time-shared by the multiple remote transmit chains. For each of the multiple remote transmit chains, the shared adaptor evaluates a set of predistortion parameters that define a predistortion to be applied to a data signal to be transmitted by the remote transmit chain in order to compensate for a non-linearity of the power amplifier in the remote transmit chain. The central node then provides the set of predistortion parameters to the remote transmit chain for utilization by the remote transmit chain to predistort the data signal to be transmitted by the remote transmit chain in order to compensate for the non-linearity of the power amplifier in the remote transmit chain.

In another embodiment, the one or more remote transmit chains include multiple remote transmit chains, and the one or more centralized predistortion components include a shared adaptor and a shared predistorter for the multiple remote transmit chains. The shared adaptor and the shared predistorter are time-shared by the multiple remote transmit chains. For each of the multiple remote transmit chains, the shared adaptor evaluates a set of predistortion parameters that define a predistortion to be applied to a data signal to be transmitted by the remote transmit chain in order to compensate for a non-linearity of the power amplifier in the remote transmit chain. The shared predistorter then predistorts the data signal to be transmitted by the remote transmit chain based on the set of predistortion parameters evaluated by the shared adaptor for the remote transmit chain to thereby provide a predistorted data signal. The central node then provides the predistorted data signal generated by the shared predistorter to the corresponding remote transmit chain for amplification and transmission.

In another embodiment, the one or more remote transmit chains include multiple remote transmit chains, and the one or more centralized predistortion components include a shared adaptor for the multiple remote transmit chains and individual predistorters for the multiple remote transmit chains. The shared adaptor is time-shared by the multiple remote transmit chains. In contrast, each of the multiple remote transmit chains has a separate individual predistorter. For each of the multiple remote transmit chains, the shared adaptor evaluates a set of predistortion parameters that define a predistortion to be applied to a data signal to be transmitted by the remote transmit chain in order to compensate for a non-linearity of the power amplifier in the remote transmit chain. The individual predistorter for the remote transmit chain then predistorts the data signal to be transmitted by the remote transmit chain based on the set of predistortion parameters evaluated by the shared adaptor for the remote transmit chain to thereby provide a predistorted data signal. The central node then provides the predistorted data signal generated by the individual predistorter for the remote transmit chain to the remote transmit chain for amplification and transmission.

Embodiments of a Multiple-Input-Multiple-Output (MIMO) transmitter including one or more shared predistortion components and corresponding adaptive predistortion processes are also disclosed. In general, the MIMO transmitter includes multiple transmit chains each including a separate power amplifier and one or more shared predistortion components that enable predistortion for one or more transmit chains in order to compensate for non-linearity of the power amplifiers in the one or more transmit chains. In one embodiment, the one or more shared predistortion components include a shared adaptor that evaluates predistortion parameters for the transmit chains of the MIMO transmitter. The shared adaptor is time-shared by the multiple transmit chains of the MIMO transmitter. For each of the multiple transmit chains, the shared adaptor evaluates a set of predistortion parameters that define a predistortion to be applied to a data signal to be transmitted by the transmit chain in order to compensate for a non-linearity of the power amplifier in the transmit chain. An individual predistorter in the transmit chain then predistorts the data signal to be transmitted by the transmit chain based on the set of predistortion parameters evaluated by the shared adaptor for the transmit chain to thereby provide a predistorted data signal. The transmit chain then amplifies and transmits the predistorted data signal.

In another embodiment, the one or more shared predistortion components of the MIMO transmitter include a shared adaptor that evaluates predistortion parameters for the transmit chains of the MIMO transmitter and a shared predistorter that predistorts data signals to be transmitted by the transmit chains based on the corresponding predistortion parameters evaluated by the shared adaptor. The shared adaptor and the shared predistorter are time-shared by the multiple transmit chains of the MIMO transmitter. For each of the multiple transmit chains, the shared adaptor evaluates a set of predistortion parameters that define a predistortion to be applied to a data signal to be transmitted by the transmit chain in order to compensate for a non-linearity of the power amplifier in the transmit chain. The shared predistorter then predistorts the data signal to be transmitted by the transmit chain based on the set of predistortion parameters evaluated by the shared adaptor for the transmit chain to thereby provide a predistorted data signal. The predistorted data signal is then provided to the transmit chain for amplification and transmission.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates an adaptive linearization scheme that predistorts a data signal to be amplified by a power amplifier to compensate for a non-linearity of the power amplifier;

FIG. 2 illustrates a system in which one or more predistortion components for one or more transmit chains are centralized at a central node according to one embodiment of the present disclosure;

FIGS. 3A and 3B are flow charts that illustrate the operation of the system of FIG. 2 according to one embodiment of the present disclosure;

FIGS. 4A and 4B are flow charts that illustrate the operation of the system of FIG. 2 according to another embodiment of the present disclosure;

FIG. 5 is a more detailed illustration of the system of FIG. 2 wherein individual adaptors and predistorters for the one or more remote transmit chains are centralized at the central node according to one embodiment of the present disclosure;

FIG. 6 is a more detailed illustration of the system of FIG. 2 wherein individual adaptors for the one or more remote transmit chains are centralized at the central node but predistorters for the one or more remote transmit chains remain distributed at the one or more remote transmit chains according to another embodiment of the present disclosure;

FIG. 7 is a more detailed illustration of the system of FIG. 2 wherein a shared adaptor and a shared predistorter for multiple remote transmit chains are centralized at the central node according to another embodiment of the present disclosure;

FIG. 8 is a more detailed illustration of the system of FIG. 2 wherein a shared adaptor for multiple remote transmit chains is centralized at the central node but predistorters for the one or more remote transmit chains remain distributed at the one or more remote transmit chains according to another embodiment of the present disclosure;

FIG. 9 is a more detailed illustration of the system of FIG. 2 wherein a shared adaptor for multiple remote transmit chains and individual predistorters for the multiple remote transmit chains are centralized at the central node according to another embodiment of the present disclosure;

FIG. 10 illustrates one embodiment of the system of FIG. 2 wherein the central node is a Hub Base Station (HBS) and the one or more remote transmit chains are incorporated into one or more Satellite Base Stations (SBSs) according to one embodiment of the present disclosure;

FIG. 11 is a block diagram of the central node of FIG. 2 according to one embodiment of the present disclosure;

FIG. 12 illustrates a Multiple-Input-Multiple-Output (MIMO) transmitter that includes a shared adaptor and a shared predistorter for multiple transmit chains according to one embodiment of the present disclosure;

FIG. 13 illustrates a MIMO transmitter that includes a shared adaptor for multiple transmit chains and individual predistorters for the multiple transmit chains according to another embodiment of the present disclosure;

FIG. 14 is a flow chart illustrating the operation of the MIMO transmitter of FIG. 12 according to one embodiment of the present disclosure;

FIG. 15 illustrates a more detailed embodiment of the utilization of the predistortion parameters in the process of FIG. 14 according to one embodiment of the present disclosure; and

FIG. 16 illustrates a more detailed embodiment of the utilization of the predistortion parameters in the process of FIG. 14 according to another embodiment of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

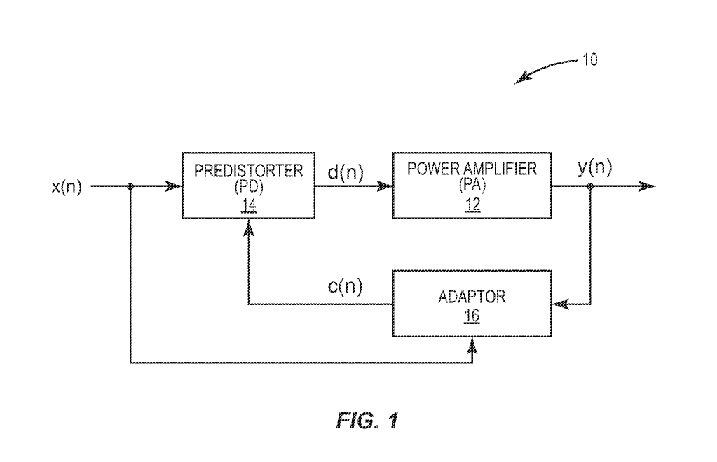

Embodiments of a centralized adaptive predistortion system that compensates for power amplifier non-linearity in one or more remote transmit chains and corresponding adaptive predistortion processes are disclosed. In addition, embodiments of a Multiple-Input-Multiple-Output (MIMO) transmitter including multiple transmit chains and one or more shared predistortion components that enable adaptive predistortion for the transmit chains and corresponding adaptive predistortion processes are disclosed. Before discussing the aforementioned embodiments, FIG. 1 provides a discussion of a general adaptive predistortion system 10.

As illustrated in FIG. 1, the adaptive predistortion system 10 includes a power amplifier (PA) 12 having a non-linear response, a predistorter (PD) 14, and an adaptor 16. The predistorter 14, or actuator, receives a data signal x(n) and predistorts the data signal x(n) based on a set of predistortion parameters c(n) provided by the adaptor 16 to provide a predistorted data signal d(n). The data signal x(n) is, in this embodiment, a baseband input signal. The set of predistortion parameters c(n) may be a vector of predistortion parameter values. As a non-limiting example, the set of predistortion parameters c(n) may include a set or vector of predistortion coefficients defining a polynomial predistortion curve. The power amplifier 12 then amplifies the predistorted data signal d(n) to provide an output signal y(n). The adaptor 16 utilizes an adaptive predistortion algorithm to evaluate, or provide values for, the set of predistortion parameters c(n) such that the set of predistortion parameters c(n) defines a predistortion to be applied by the predistorter 14 to the data signal x(n) to compensate, or substantially cancel, a non-linearity of the power amplifier 12. While any suitable adaptive predistortion algorithm may be used, in general, the adaptor 16 compares a feedback signal from an output of the power amplifier 12 to a reference signal and, based on this comparison, evaluates the set of predistortion parameters c(n). In this embodiment, the reference signal is the data signal x(n) and the feedback signal corresponds to the output signal y(n). As one of ordinary skill in the art will appreciate upon reading this disclosure, gain, delay, and phase adjustments are applied to the output signal y(n) and/or the data signal x(n) to obtain the actual reference and feedback signals that are compared by the adaptor 16.

Note that the predistorter 14 may operate in the digital or analog domain. In one embodiment, the predistorter 14 operates at digital baseband, in which case both the data signal x(n) and the predistorted data signal d(n) are at digital baseband and the predistorted data signal d(n) is converted to analog and upconverted to a desired radio frequency prior to amplification by the power amplifier 12. In another embodiment, the predistorter 14 operates in the analog domain at baseband, in which case the both the data signal x(n) and the predistorted data signal d(n) are analog signals and the predistorted data signal d(n) is upconverted to a desired radio frequency prior to amplification by the power amplifier 12. Note that for the discussion herein, predistortion is assumed to be at baseband in either the digital or analog domain. However, the discussion herein is also applicable to embodiments where predistortion is performed at an upconverted frequency in either the digital or analog domain.

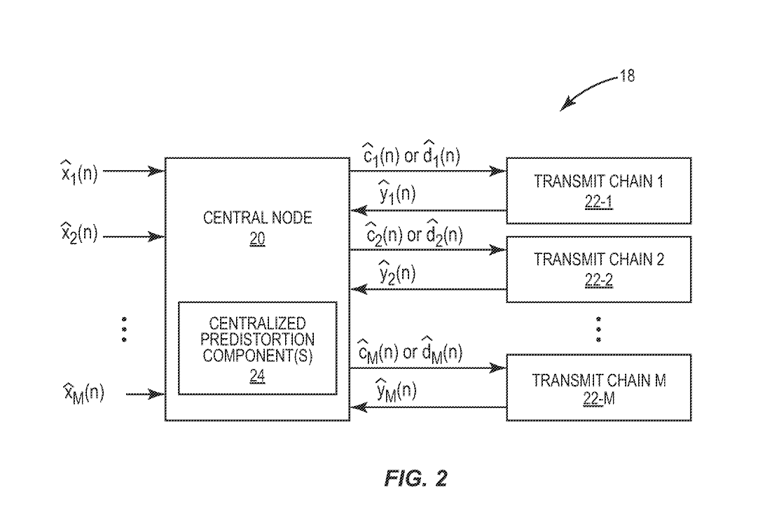

FIG. 2 illustrates a centralized adaptive predistortion system 18 according to one embodiment of the present disclosure. The centralized adaptive predistortion system 18 includes a central node 20 and number (M) of remote transmit chains 22-1 through 22-M, which are generally referred to herein collectively as remote transmit chains 22 or individually as remote transmit chain 22. The central node 20 is implemented in hardware or a combination of hardware and software and includes one or more centralized predistortion components 24. As discussed in detail below, depending on the particular embodiment, the one or more centralized predistortion components 24 may include:
separate individual adaptors for the remote transmit chains 22,
separate individual adaptors and separate individual predistorters for the remote transmit chains 22,
a shared adaptor for the remote transmit chains 22,
a shared adaptor and a shared predistorter for the remote transmit chains 22, or
a shared adaptor and separate individual predistorters for the remote transmit chains 22.
   Each of the one or more centralized predistortion components 24 is preferably implemented in hardware or a combination of hardware and software. For example, each of the one or more centralized predistortion components 24 is preferably implemented as a microprocessor that executes corresponding software providing the desired functionality of the centralized predistortion component 24, a Digital Signal Processing (DSP) processor, an Application Specific Integrated Circuit (ASIC), Field Programmable Gate Array (FPGA), or similar hardware device.

The remote transmit chains 22 are generally transmit chains located remotely from the central node 20. In other words, the remote transmit chains 22 are located at different geographic location(s) than the central node 20. As discussed below, each of the remote transmit chains 22 includes a number of digital and analog components including a corresponding non-linear power amplifier. The central node 20 and the remote transmit chains 22 are preferably connected by a wireless network such as a cellular network. However, in an alternative embodiment, the central node 20 and the remote transmit chains 22 are connected via a wired network (e.g., a fiber backhaul network of a cellular network).

In operation, the one or more centralized predistortion components 24 receive data signals (\hat{x}₁(n)K \hat{x}_{M})) to be transmitted by the remote transmit chains 22-1 through 22-M, respectively. The data signal \hat{x}₁(n) is a data signal to be transmitted by the remote transmit chain 22-1, the data signal \hat{x}₂(n) is a data signal to be transmitted by the remote transmit chain 22-2, and so on. In this embodiment, the data signals (\hat{x}₁(n)K \hat{x}_{M}(n)) are digital baseband input signals. However, the data signals (\hat{x}₁(n)K \hat{x}_{M}(n)) may alternatively be analog baseband signals, upconverted (e.g., very-low intermediate frequency (VLIF) or intermediate frequency (IF)) digital signals, or upconverted analog signals. In addition, the one or more centralized predistortion components 24 receive feedback signals from the corresponding remote transmit chains 22. In this embodiment, the feedback signals are output signals ŷ₁(n)K ŷ_{M}(n)) of the corresponding remote transmit chains 22. Note, however, that the feedback signals may alternatively be processed versions of the output signals (ŷ₁(n)K ŷ_{M}(n)), e.g., attenuated by 1/G where G is a gain of the power amplifier of the corresponding remote transmit chain 22, delayed, phase-adjusted, and/or the like in order to enable a comparison of the feedback signal to a reference signal for purposes of adaptive linearization.

Based on the data signals (\hat{x}₁(n)K \hat{x}_{M}(n)) and the feedback signals (ŷ₁(n)K ŷ_{M}(n)), the one or more centralized predistortion components 24 generate an output to be utilized by the remote transmit chains 22 to compensate for the non-linearity of the power amplifiers in the remote transmit chains 22. In this embodiment, the output of the one or more centralized predistortion components 24 is either:
sets of predistortion parameters (ĉ₁(n)K ĉ_{M}(n)) that define a predistortion to be applied to the corresponding data signals (\hat{x}₁(n)K \hat{x}_{M}(n)) in order to compensate for the non-linearity of the power amplifiers in the corresponding remote transmit chains 22, or
predistorted data signals (\hat{d}₁(n)K \hat{d}_{M}(n)) generated by predistorting the corresponding data signals (\hat{x}₁(n)K \hat{x}_{M}(n)) in order to compensate for the non-linearity of the power amplifiers in the corresponding remote transmit chains 22.
   Note that the one or more centralized predistortion components 24 may operate in either the digital or analog domain. Further, the one or more centralized predistortion components 24 may operate at baseband or at a VLIF or IF frequency.

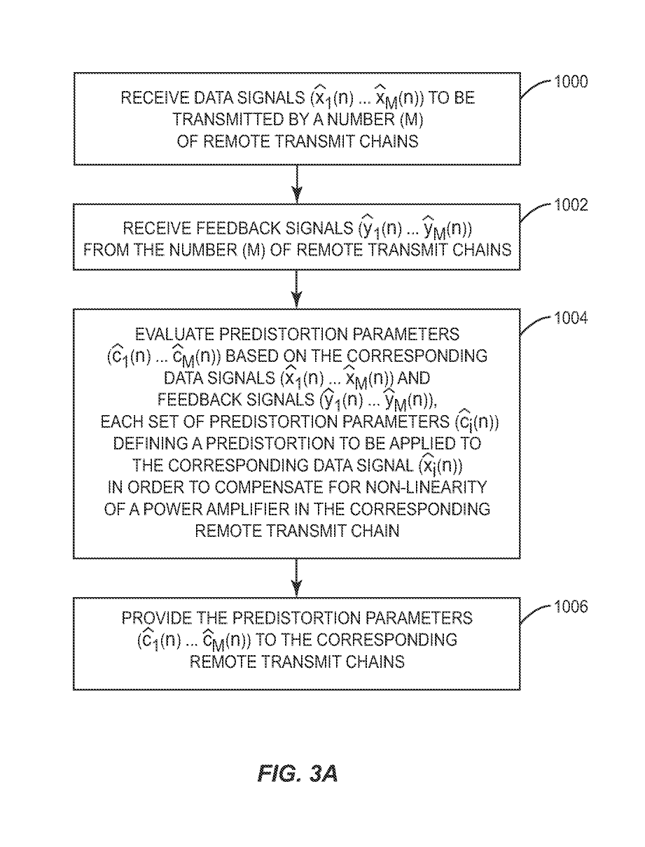

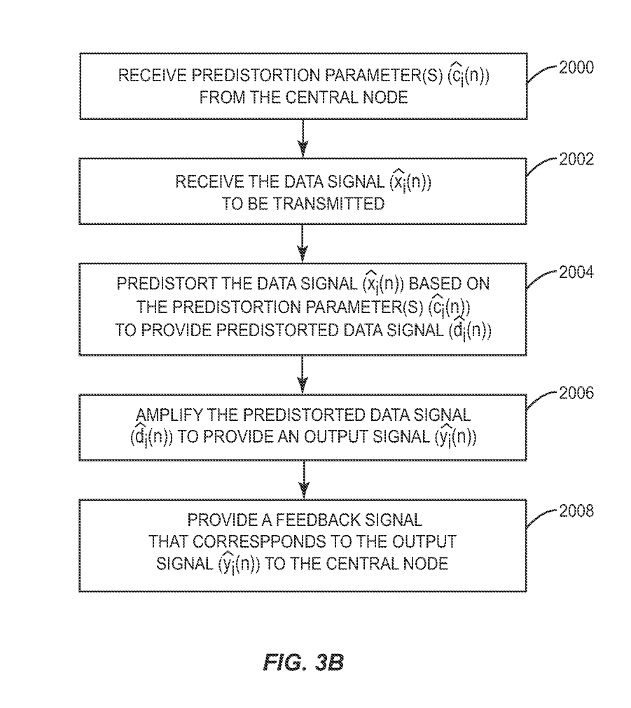

FIGS. 3A and 3B illustrate the operation of the centralized adaptive predistortion system 18 of FIG. 2 according to one embodiment of the present disclosure from the perspective of the central node 20 and the perspective of the remote transmit chains 22, respectively. FIG. 3A is a flow chart that illustrates the operation of the central node 20 of FIG. 2 according to an embodiment in which the one or more centralized predistortion components 24 evaluate sets of predistortion parameters (ĉ₁(n)K ĉ_{M}(n)) for the remote transmit chains 22 and provide the sets of predistortion parameters (ĉ₁(n)K ĉ_{M}(n)) to the corresponding remote transmit chains 22. More specifically, first, the central node 20 receives the data signals (\hat{x}₁(n)K \hat{x}_{M}(n)) to be transmitted by the remote transmit chains 22 (step 1000). In addition, the central node 20 receives the feedback signals (ŷ₁(n)K ŷ_{M}(n)) from the remote transmit chains 22 (step 1002). The one or more centralized predistortion components 24 evaluate the sets of predistortion parameters (ĉ₁(n)K ĉ_{M}(n)) based on the corresponding data signals (\hat{x}₁(n)K \hat{x}_{M}(n)) and feedback signals (ŷ₁(n)K ŷ_{M}(n)) (step 1004). Each set of predistortion parameters (ĉᵢ(n)) defines a predistortion to be applied to the corresponding data signal (\hat{x}ᵢ(n)) in order to compensate for the non-linearity of the power amplifier in the i-th remote transmit chain 22-i. Notably, each set, or vector, of predistortion parameters (ĉᵢ(n)) is preferably a set of predistortion coefficients. The one or more centralized predistortion components 24 provide the sets of predistortion parameters (ĉ₁(n)K ĉ_{M}(n)) to the corresponding remote transmit chains 22 (step 1006).

More specifically, using the remote transmit chain 22-1 as an example, the one or more centralized predistortion components 24 receive the data signal (\hat{x}₁(n)) to be transmitted by the remote transmit chain 22-1 and the feedback signal (ŷ₁(n)) from the remote transmit chain 22-1. The one or more centralized predistortion components 24 then evaluate the set of predistortion parameters (ĉ₁(n)) that compensates for a non-linearity of the power amplifier in the remote transmit chain 22-1 based on a comparison of the data signal (\hat{x}₁(n)) and the feedback signal (ŷ₁(n)). Note that, as will be appreciated by one of ordinary skill in the art, gain, phase, and/or delay adjustments may be applied to the data signal (\hat{x}₁(n)) and/or the feedback signal (ŷ₁(n)) at the central node 20 and/or the remote transmit chain 22-1 in order to obtain the actual reference and feedback signals for the comparison. Further, any suitable algorithm for adaptive predistortion power amplifier linearization may be used to evaluate the set of predistortion parameters (ĉ₁(n)). The one or more centralized predistortion components 24 then provide the set of predistortion parameters (ĉ₁(n)) to the remote transmit chain 22-1 via a wired or wireless connection between the central node 20 and the remote transmit chain 22-1, depending on the particular implementation. As discussed below, the remote transmit chain 22-1 then utilizes the set of predistortion parameters (ĉ₁(n)) to predistort the data signal (\hat{x}₁(n)) in order to compensate for the non-linearity of the power amplifier in the remote transmit chain 22-1.

Notably, the process of FIG. 3A is repeated periodically or otherwise such that the sets of predistortion parameters (ĉ₁(n)K ĉ_{M}(n)) are updated over time, thereby providing adaptive linearization. Preferably, the sets of predistortion parameters (ĉ₁(n)K ĉ_{M}(n)) are quasi-static in that they are updated infrequently (i.e., they are static for many data samples). The frequency at which the sets of predistortion parameters (ĉ₁(n)K ĉ_{M}(n)) are updated may vary depending on the particular application.

FIG. 3B illustrates the operation of the remote transmit chains 22 according to an embodiment in which the remote transmit chains 22 predistort the data signals (\hat{x}₁(n)K \hat{x}_{M}(n)) based on the corresponding sets of predistortion parameters (ĉ₁(n)K ĉ_{M}(n)) received from the central node 20 as discussed above with respect to FIG. 3A. Using the i-th remote transmit chain 22-i as an example, the remote transmit chain 22-i receives the set of predistortion parameters (ĉᵢ(n)) from the central node 20 (step 2000). In addition, the remote transmit chain 22-i receives the data signal (\hat{x}ᵢ(n)) to be transmitted by the remote transmit chain 22-i (step 2002). The remote transmit chain 22-i may receive the data signal (\hat{x}ᵢ(n)) from, for example, the central node 20, but is not limited thereto.

The remote transmit chain 22-i predistorts the data signal (\hat{x}ᵢ(n)) based on the set of predistortion parameters (ĉᵢ(n)) to provide a predistorted data signal (\hat{d}ᵢ(n)) (step 2004). In other words, using the set of predistortion parameters (ĉᵢ(n)), a predistortion is applied to the data signal (\hat{x}ᵢ(n)) that compensates for the non-linearity of the power amplifier in the remote transmit chain 22-i. The predistorted data signal (\hat{d}ᵢ(n)) is then amplified by the power amplifier in the remote transmit chain 22-i to provide an output signal (ŷᵢ(n)) that is transmitted by the remote transmit chain 22-i (step 2006). The predistortion is such that the output signal (ŷᵢ(n)) appears as though the power amplifier in the remote transmit chain 22-i is a linear, rather than a non-linear, power amplifier. The remote transmit chain 22-l then provides a feedback signal that corresponds to the output signal (ŷᵢ(n)) to the central node 20 (step 2008). As noted above, the feedback signal may be the output signal (ŷᵢ(n)). Alternatively, a gain, delay, and/or phase of the output signal (ŷᵢ(n)) may be adjusted to provide the feedback signal. The gate, delay, and phase adjustments may be such that the feedback signal is aligned with the reference signal for comparison of the two signals when subsequently updating the set of predistortion parameters (ĉᵢ(n)) at the central node 20. Note that the receiving step 2000 and the providing of the feedback signal in step 2008 may be continuous. However, in the preferred embodiment, the set of predistortion parameters (ĉᵢ(n)) is updated periodically at a desired frequency, rather than continuously. As such, in this preferred embodiment, while steps 2002 through 2006 are continuous as long as there is data to be transmitted, steps 2000 and 2008 are only performed periodically at the update frequency for the set of predistortion parameters (ĉᵢ(n)).

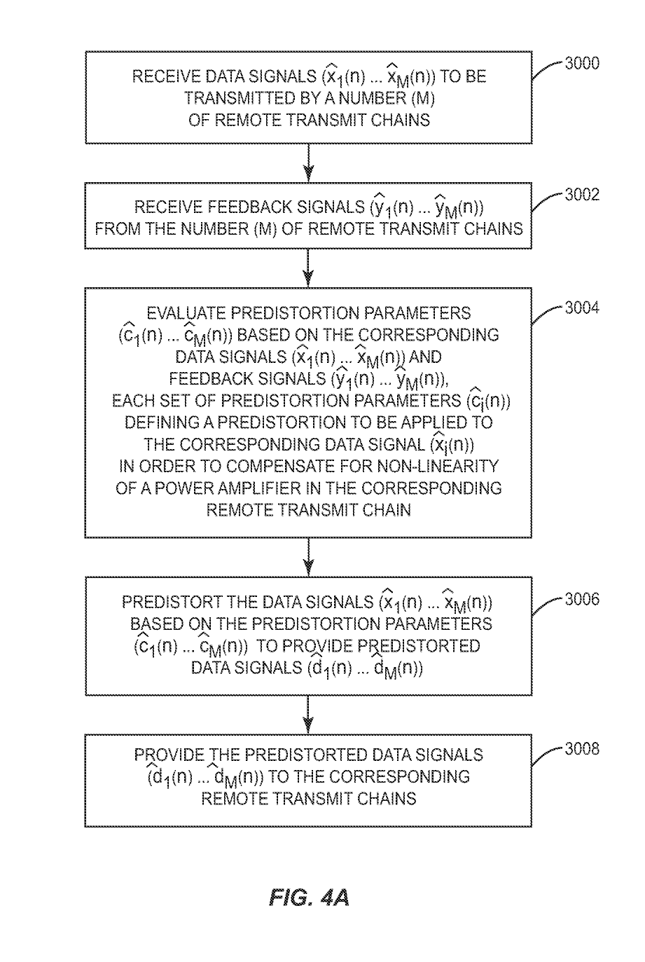

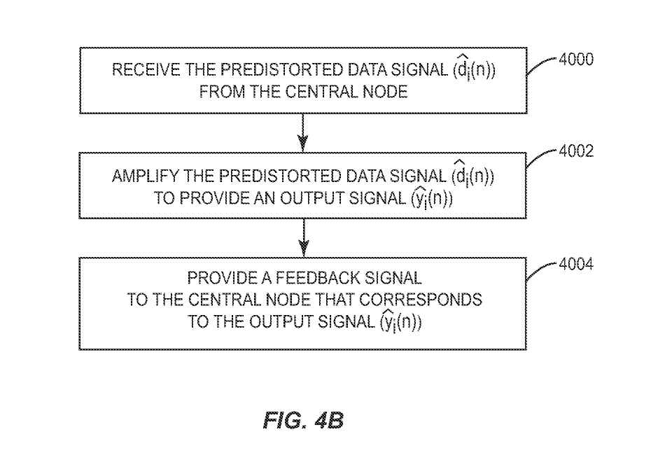

FIGS. 4A and 4B illustrate the operation of the centralized adaptive predistortion system 18 of FIG. 2 according to another embodiment of the present disclosure from the perspective of the central node 20 and the perspective of the remote transmit chains 22, respectively. FIG. 4A is a flow chart that illustrates the operation of the central node 20 of FIG. 2 according to an embodiment in which the one or more centralized predistortion components 24 evaluate sets of predistortion parameters (ĉ₁(n)K ĉ_{M}(n)) for the remote transmit chains 22, predistort the data signals (\hat{x}₁(n)K \hat{x}_{M}(n)) to be transmitted by the remote transmit chains 22, and provide the resulting predistorted data signals (ŷ₁(n)K ŷ_{M}(n)) to the corresponding remote transmit chains 22. More specifically, first, the central node 20 receives the data signals (\hat{x}₁(n)K \hat{x}_{M}(n)) to be transmitted by the remote transmit chains 22 (step 3000). In addition, the central node 20 receives the feedback signals (ŷ₁(n)K ŷ_{M}(n)) from the remote transmit chains 22 (step 3002).

The one or more centralized predistortion components 24 evaluate the sets of predistortion parameters (ĉ₁(n)K ĉ_{M}(n)) based on the corresponding data signals (\hat{x}₁(n)K \hat{x}_{M}(n)) and feedback signals (ŷ₁(n)K ŷ_{M}(n)) (step 3004). Each set of predistortion parameters (ĉᵢ(n)) defines a predistortion to be applied to the corresponding data signal (\hat{x}ᵢ(n)) in order to compensate for the non-linearity of the power amplifier in the i-th remote transmit chain 22-i. Next, in this embodiment, the one or more centralized predistortion components 24 predistort the data signals (\hat{x}₁(n)K \hat{x}_{M}(n)) based on the corresponding sets of predistortion parameters (ĉ₁(n)K ĉ_{M}(n)) to provide corresponding predistorted data signals (\hat{d}₁(n)K \hat{d}_{M}(n)) (step 3006). The one or more centralized predistortion components 24 then provide the predistorted data signals (\hat{d}₁(n)K \hat{d}_{M}(n)) to the corresponding remote transmit chains 22 (step 3008).

More specifically, using the remote transmit chain 22-1 as an example, the one or more centralized predistortion components 24 receive the data signal (\hat{x}₁(n)) to be transmitted by the remote transmit chain 22-1 and the feedback signal (ŷ₁(n)) from the remote transmit chain 22-1. The one or more centralized predistortion components 24 then evaluate the set of predistortion parameters (ĉ₁(n)) that compensates for a non-linearity of the power amplifier in the remote transmit chain 22-1 based on a comparison of the data signal (\hat{x}₁(n)) and the feedback signal (ŷ₁(n)). Note that, as will be appreciated by one of ordinary skill in the art, gain, phase, and/or delay adjustments may be applied to the data signal (\hat{x}₁(n)) and/or the feedback signal (ŷ₁(n)) at the central node 20 and/or the remote transmit chain 22-1 in order to obtain the actual reference and feedback signals for the comparison. Further, any suitable algorithm for adaptive predistortion power amplifier linearization may be used to evaluate the set of predistortion parameters (ĉ₁(n)). The one or more centralized predistortion components 24 then predistort the data signal (x₁(n)) based on the set of predistortion parameters (ĉ₁(n)) to thereby provide the predistorted data signal (\hat{d}₁(n)). Lastly, the one or more centralized predistortion components 24 provide the predistorted data signal (\hat{d}₁(n)) to the remote transmit chain 22-1 via a wired or wireless connection between the central node 20 and the remote transmit chain 22-1, depending on the particular implementation. As discussed below, the remote transmit chain 22-1 then amplifies the predistorted data signal (\hat{d}₁(n)) and transmits the resulting output signal (ŷ₁(n)).

Notably, in the process of FIG. 4A, steps 3000, 3006, and 3008 are preferably performed continuously as long as there is data to be transmitted. However, steps 3002 and 3004 are preferably repeated only periodically at a desired frequency at which the sets of predistortion parameters (ĉ₁(n)K ĉ_{M}(n)) are to be updated over time. Preferably, the sets of predistortion parameters (ĉ₁(n)K ĉ_{M}(n)) are quasi-static in that they are updated infrequently (i.e., are static for many data samples). The frequency at which the sets of predistortion parameters (ĉ₁(n)K ĉ_{M}(n)) are updated may vary depending on the particular application. Further, the sets of predistortion parameters (ĉ₁(n)K ĉ_{M}(n)) may be updated at the same frequency or at different frequencies depending on the particular implementation.

FIG. 4B illustrates the operation of the remote transmit chains 22 according to an embodiment in which the remote transmit chains 22 receive the predistorted data signals (\hat{d}₁(n)K \hat{d}_{M}(n)) from the central node 20, amplify the predistorted data signals (\hat{d}₁(n)K \hat{d}_{M}(n)), and transmit the resulting output signals (ŷ₁(n)K ŷ_{M}(n)). More specifically, using the i-th remote transmit chain 22-i as an example, the remote transmit chain 22-i receives the predistorted data signal (\hat{d}ᵢ(n)) from the central node 20 (step 4000). The predistorted data signal (\hat{d}ᵢ(n)) is then amplified by the power amplifier in the remote transmit chain 22-i to provide an output signal (ŷᵢ(n)) that is transmitted by the remote transmit chain 22-i (step 4002). The predistortion is such that the output signal (ŷᵢ(n)) appears as though the power amplifier in the remote transmit chain 22-i is a linear, rather than a non-linear, power amplifier. The remote transmit chain 22-i then provides a feedback signal that corresponds to the output signal (ŷᵢ(n)) to the central node 20 (step 4004). As noted above, the feedback signal may be the output signal (ŷᵢ(n)). Alternatively, a gain, delay, and/or phase of the output signal (ŷᵢ(n)) may be adjusted to provide the feedback signal. The gate, delay, and phase adjustments may be such that the feedback signal is aligned with the reference signal for comparison of the two signals when subsequently updating the set of predistortion parameters (ĉᵢ(n)) at the central node 20. Note that step 4004 may be continuous. However, in the preferred embodiment, step 4004 is performed periodically at a desired update frequency for the set of predistortion parameters (ĉᵢ(n)). As such, in this preferred embodiment, while steps 4000 and 4002 are performed continuously as long as there is data to be transmitted, step 4004 is only performed periodically at the update frequency for the set of predistortion parameters (ĉᵢ(n))

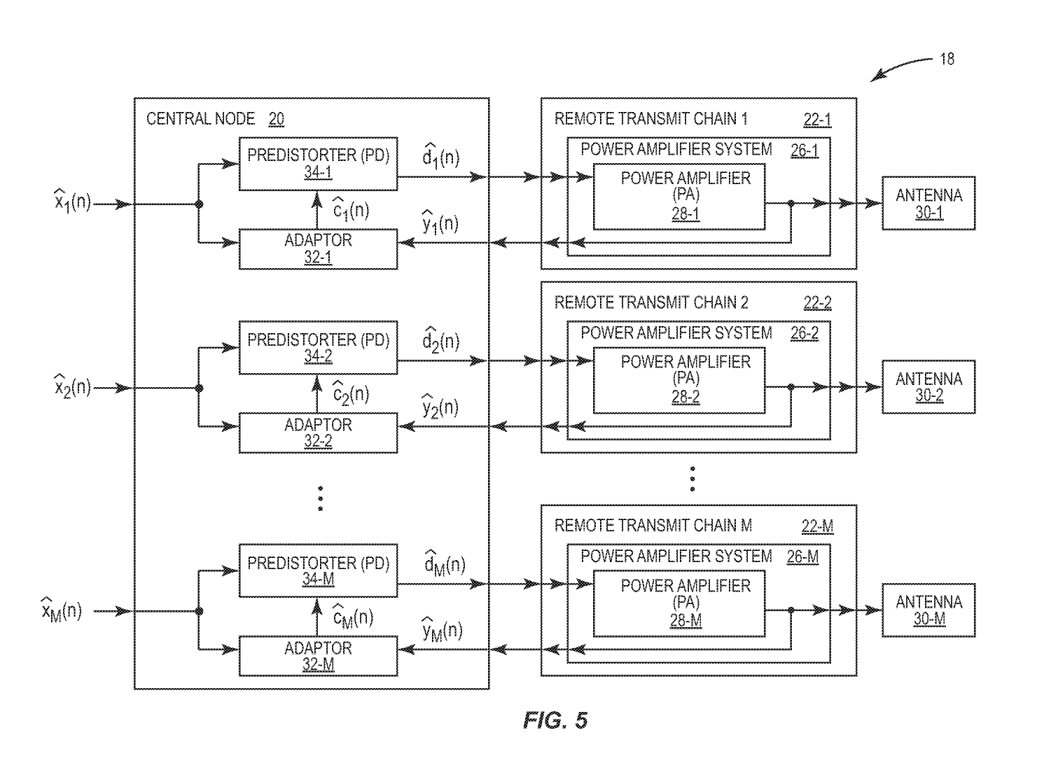

FIG. 5 is a more detailed illustration of the centralized adaptive predistortion system 18 of FIG. 2 according to a first embodiment of the present disclosure. As illustrated, the remote transmit chains 22-1 through 22-M include power amplifier systems 26-1 through 26-M (generally referred to herein collectively as power amplifier systems 26 and individually as power amplifier system 26) having corresponding power amplifiers 28-1 through 28-M (generally referred to herein collectively as power amplifiers 28 and individually as power amplifier 28), respectively. The output signals (ŷ₁(n)K ŷ_{M}(n)) from the remote transmit chains 22-1 through 22-M are transmitted via corresponding antennas 30-1 through 30-M (generally referred to herein collectively as antennas 30 and individually as antenna 30) coupled to outputs of the power amplifiers 28-1 through 28-M, respectively. In this embodiment, the one or more centralized predistortion components 24 (FIG. 2) include individual adaptors 32-1 through 32-M (generally referred to herein collectively as individual adaptors 32 and individually as individual adaptor 32) and individual predistorters 34-1 through 34-M (generally referred to herein collectively as individual predistorters 34 and individually as individual predistorter 34) for the remote transmit chains 22-1 through 22-M, respectively.

The individual adaptors 32 are separate adaptors that are allocated to or otherwise designated for the corresponding remote transmit chains 22. Therefore, for example, the individual adaptor 32-1 operates to evaluate predistortion parameters for the remote transmit chain 22-1. The individual adaptors 32 are implemented in hardware or a combination of hardware and software. In one embodiment, the individual adaptors 32 are implemented as separate hardware devices such as separate microprocessors that execute corresponding software instructions, separate DSP processors, separate ASICs, separate FPGAs, or similar separate hardware components. However, the present disclosure is not limited thereto. The individual adaptors 32 or sub-groups of the individual adaptors 32 may alternatively be implemented on a single hardware component (e.g., a single microprocessor, a single DSP processor, a single ASIC, or a single FPGA).

The individual predistorters 34 are separate predistorters that are allocated to or otherwise designated for the corresponding remote transmit chains 22. Therefore, for example, the individual predistorter 34-1 operates to predistort the data signal (\hat{x}₁(n)) to be transmitted by the remote transmit chain 22-1 based on the set of predistortion parameters (ĉ₁(n)) evaluated by the individual adaptor 32-1 for the remote transmit chain 22-1 to thereby provide the predistorted data signal (ŷ₁(n)) that is sent to the remote transmit chain 22-1 for amplification and transmission. The individual predistorters 34 are implemented in hardware or a combination of hardware and software. In one embodiment, the individual predistorters 34 are implemented as separate hardware devices such as separate microprocessors that execute corresponding software instructions, separate DSP processors, separate ASICs, separate FPGAs, or similar separate hardware components. However, the present disclosure is not limited thereto. The individual predistorters 34 or sub-groups of the individual predistorters 34 may alternatively be implemented on a single hardware component (e.g., a single microprocessor, a single DSP processor, a single ASIC, or a single FPGA). As another alternative, the corresponding pairs of individual adaptors 32 and individual predistorters 34 may be implemented on the same hardware component. For example, the individual adaptor 32-1 and the individual predistorter 34-1 may be implemented on a single hardware component (e.g., a single microprocessor, a single DSP processor, a single ASIC, or a single FPGA).

In operation, using the i-th remote transmit chain 22-i as an example, the individual adaptor 32-i for the remote transmit chain 22-i evaluates the set of predistortion parameters (ĉᵢ(n)) that defines a predistortion to be applied to the data signal (\hat{x}ᵢ(n)) to be transmitted by the remote transmit chain 22-i in order to compensate for a non-linearity of the power amplifier 28-i in the remote transmit chain 22-i. As discussed above, the set of predistortion parameters (ĉᵢ(n)) is evaluated based on a comparison of a reference signal, which in this embodiment is the data signal (\hat{x}ᵢ(n)), and a feedback signal, which in this embodiment is the output signal (ŷᵢ(n)) of the power amplifier 28-i, according to a predistortion algorithm. As will be appreciated by one of ordinary skill in the art, numerous algorithms for evaluating predistortion parameters (e.g., predistortion coefficients) are well-known in the art of power amplifier linearization. Any of these predistortion algorithms may be used and the present disclosure is not limited to any particular algorithm. Using the set of predistortion parameters ĉᵢ(n)), the individual predistorter 34-i for the remote transmit chain 22-i predistorts the data signal (\hat{x}ᵢ(n)) to thereby provide the predistorted data signal (\hat{d}ᵢ(n)). The central node 20 then communicates the predistorted data signal (\hat{d}ᵢ(n)) to the remote transmit chain 22-i via a wired or wireless connection, depending on the particular implementation.

Upon receiving the predistorted data signal (\hat{d}ᵢ(n)), the remote transmit chain 22-i provides the predistorted data signal (\hat{d}ᵢ(n)) to the power amplifier system 26-i for amplification by the power amplifier 28-i. The resulting output signal (ŷᵢ(n)) is provided to the antenna 30-i for transmission. It should be noted that, as will be appreciated by one having ordinary skill in the art, the remote transmit chain 22-i may include components in addition to the power amplifier system 26-i such as, for example, a wired or wireless communication interface for receiving the predistorted data signal (\hat{d}ᵢ(n)) from the central node 20, an upconverter for upconverting the predistorted data signal (\hat{d}ᵢ(n)) to a desired transmit frequency, or the like. Likewise, the power amplifier system 26-i may include components in addition to the power amplifier 28-i such as, for example, power control circuitry, an impedance matching network, or the like.

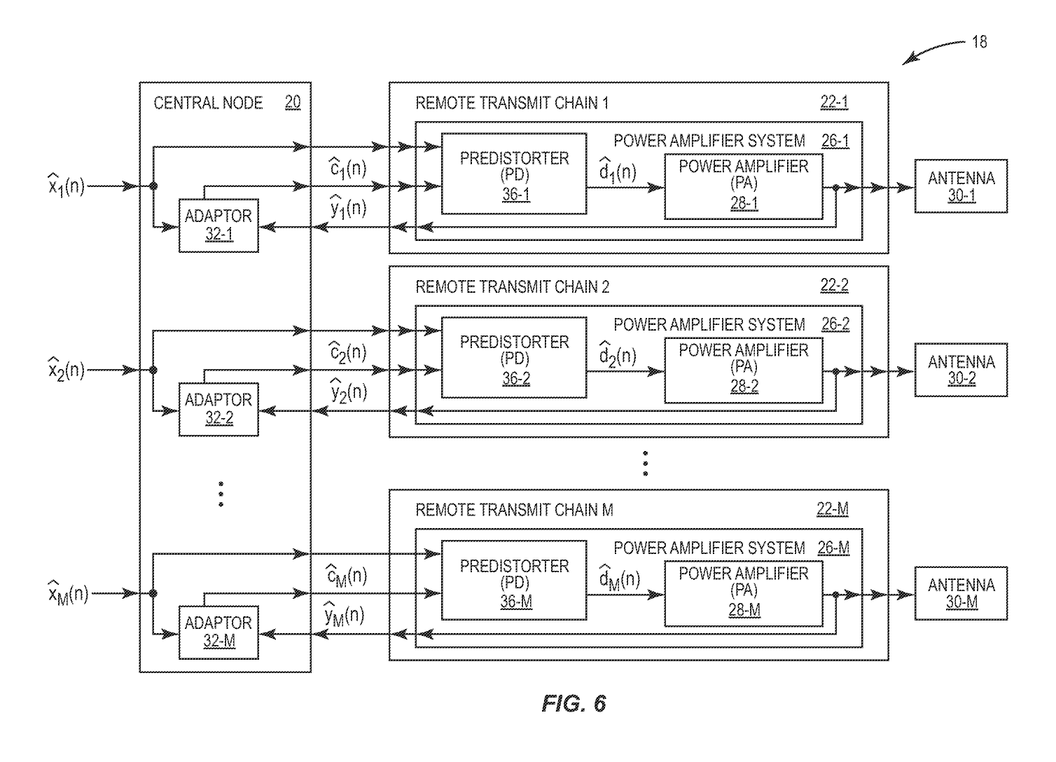

FIG. 6 is a more detailed illustration of the centralized adaptive predistortion system 18 of FIG. 2 according to a second embodiment of the present disclosure. This embodiment is similar to that of FIG. 5. However, in this embodiment, the one or more centralized predistortion components 24 (FIG. 2) include the individual adaptors 32 but not the individual predistorters 34 (FIG. 5). Rather, predistortion is performed by predistorters 36-1 through 36-M (generally referred to herein collectively as predistorters 36 and individually as predistorter 36) included in the remote transmit chains 22-1 through 22-M, respectively. The predistorters 36 are implemented as hardware components in the corresponding remote transmit chains 22 (e.g., microprocessors, DSP processors, ASICs, FPGAs, or similar hardware components). Note that the hardware components may, in some embodiments, be used to implement additional components of the corresponding remote transmit chains 22.

In operation, using the i-th remote transmit chain 22-i as an example, the individual adaptor 32-i for the remote transmit chain 22-i evaluates the set of predistortion parameters (ĉᵢ(n)) that defines a predistortion to be applied to the data signal (\hat{x}ᵢ(n)) to be transmitted by the remote transmit chain 22-i in order to compensate for a non-linearity of the power amplifier 28-i in the remote transmit chain 22-i. As discussed above, the set of predistortion parameters (ĉᵢ(n)) is evaluated based on a comparison of a reference signal, which in this embodiment is the data signal (\hat{x}ᵢ(n)), and a feedback signal, which in this embodiment is the output signal (ŷᵢ(n)) of the power amplifier 28-i, according to a predistortion algorithm. As will be appreciated by one of ordinary skill in the art, numerous algorithms for evaluating predistortion parameters (e.g., predistortion coefficients) are well-known in the art of power amplifier linearization. Any of these predistortion algorithms may be used and the present disclosure is not limited to any particular algorithm. The central node 20 then communicates the set of predistortion parameters (ĉᵢ(n)) to the remote transmit chain 22-i via a wired or wireless connection, depending on the particular implementation.

Upon receiving the set of predistortion parameters (ĉᵢ(n)), the remote transmit chain 22-i provides the set of predistortion parameters (ĉᵢ(n)) to the predistorter 36-i of the remote transmit chain 22-i. Using the set of predistortion parameters (ĉᵢ(n)), the predistorter 36-i predistorts the data signal (\hat{x}ᵢ(n)) to thereby provide the predistorted data signal (\hat{d}ᵢ(n)). The predistorted data signal (\hat{d}ᵢ(n)) is then provided to the power amplifier system 26-i for amplification by the power amplifier 28-i. The resulting output signal (ŷᵢ(n)) is provided to the antenna 30-i for transmission. It should be noted that, as will be appreciated by one having ordinary skill in the art, the remote transmit chain 22-i may include components in addition to the power amplifier system 26-i such as, for example, one or more wired or wireless communication interfaces for receiving the data signal (\hat{x}ᵢ(n)) and the set of predistortion parameters (ĉᵢ(n)) from the central node 20, an upconverter for upconverting the predistorted data signal (\hat{d}ᵢ(n)) to a desired transmit frequency, or the like. Likewise, the power amplifier system 26-i may include components in addition to the power amplifier 28-i such as, for example, power control circuitry, an impedance matching network, or the like.

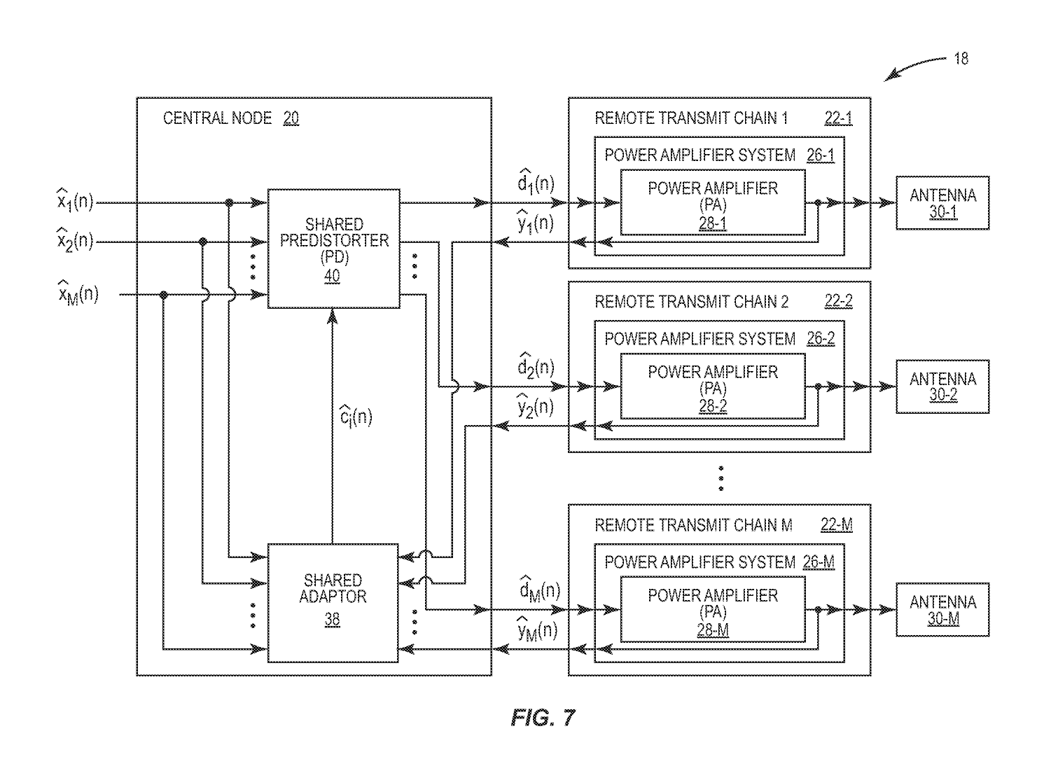

FIG. 7 is a more detailed illustration of the centralized adaptive predistortion system 18 of FIG. 2 according to a third embodiment of the present disclosure. This embodiment is similar to that of FIG. 5. However, in this embodiment, the one or more centralized predistortion components 24 (FIG. 2) include a shared adaptor 38 and a shared predistorter 40. The shared adaptor 38 is implemented in hardware or a combination of hardware and software (e.g., a microprocessor operating to execute corresponding software instructions, a DSP processor, an ASIC, an FPGA, or similar hardware component). In general, the shared adaptor 38 is time-shared by the remote transmit chains 22 such that the shared adaptor 38 operates to evaluate the sets of predistortion parameters (ĉ₁(n)K ĉ_{M}(n)) for all of the remote transmit chains 22-1 through 22-M. Similarly, the shared predistorter 40 is implemented in hardware or a combination of hardware and software (e.g., a microprocessor operating to execute corresponding software instructions, a DSP processor, an ASIC, an FPGA, or similar hardware component). Note that in one embodiment, the shared adaptor 38 and the shared predistorter 40 are implemented on separate hardware components. In another embodiment, the shared adaptor 38 and the shared predistorter 40 are implemented on a single hardware component (e.g., on the same microprocessor, on the same DSP processor, on the same ASIC, or on the same FPGA). In general, the shared predistorter 40 is time-shared by the remote transmit chains 22 such that the shared predistorter 40 operates to predistort the data signals (\hat{x}₁(n)K \hat{x}_{M}(n)) based on the corresponding sets of predistortion parameters (ĉ₁(n)K ĉ_{M}(n)) evaluated by the shared adaptor 38 for all of the remote transmit chains 22-1 through 22-M.

In operation, during a time-slot allocated for the i-th remote transmit chain 22-i as an example, the shared adaptor 38 evaluates the set of predistortion parameters (ĉᵢ(n)) that defines a predistortion to be applied to the data signal (\hat{x}ᵢ(n)) to be transmitted by the remote transmit chain 22-i in order to compensate for a non-linearity of the power amplifier 28-i in the remote transmit chain 22-i. As discussed above, the set of predistortion parameters (ĉᵢ(n)) is evaluated based on a comparison of a reference signal, which in this embodiment is the data signal (\hat{x}ᵢ(n)), and a feedback signal, which in this embodiment is the output signal (ŷᵢ(n)) of the power amplifier 28-i, according to a predistortion algorithm. As will be appreciated by one of ordinary skill in the art, numerous algorithms for evaluating predistortion parameters (e.g., predistortion coefficients) are well-known in the art of power amplifier linearization. Any of these predistortion algorithms may be used and the present disclosure is not limited to any particular algorithm. Using the set of predistortion parameters (ĉᵢ(n)), the shared predistorter 40 predistorts the data signal (\hat{x}ᵢ(n)) during a time-slot allocated to the remote transmit chain 22-i to thereby provide the predistorted data signal (\hat{d}ᵢ(n)). The central node 20 then communicates the predistorted data signal (\hat{d}ᵢ(n)) to the remote transmit chain 22-i via a wired or wireless connection, depending on the particular implementation.

Upon receiving the predistorted data signal (\hat{d}ᵢ(n)) from the central node 20, the remote transmit chain 22-i provides the predistorted data signal (\hat{d}ᵢ(n)) to the power amplifier system 26-i for amplification by the power amplifier 28-i. The resulting output signal (ŷᵢ(n)) is provided to the antenna 30-i for transmission. It should be noted that, as will be appreciated by one having ordinary skill in the art, the remote transmit chain 22-i may include components in addition to the power amplifier system 26-i such as, for example, a wired or wireless communication interface for receiving the predistorted data signal (\hat{d}ᵢ(n)) from the central node 20, an upconverter for upconverting the predistorted data signal (\hat{d}ᵢ(n)) to a desired transmit frequency, or the like. Likewise, the power amplifier system 26-i may include components in addition to the power amplifier 28-i such as, for example, power control circuitry, an impedance matching network, or the like.

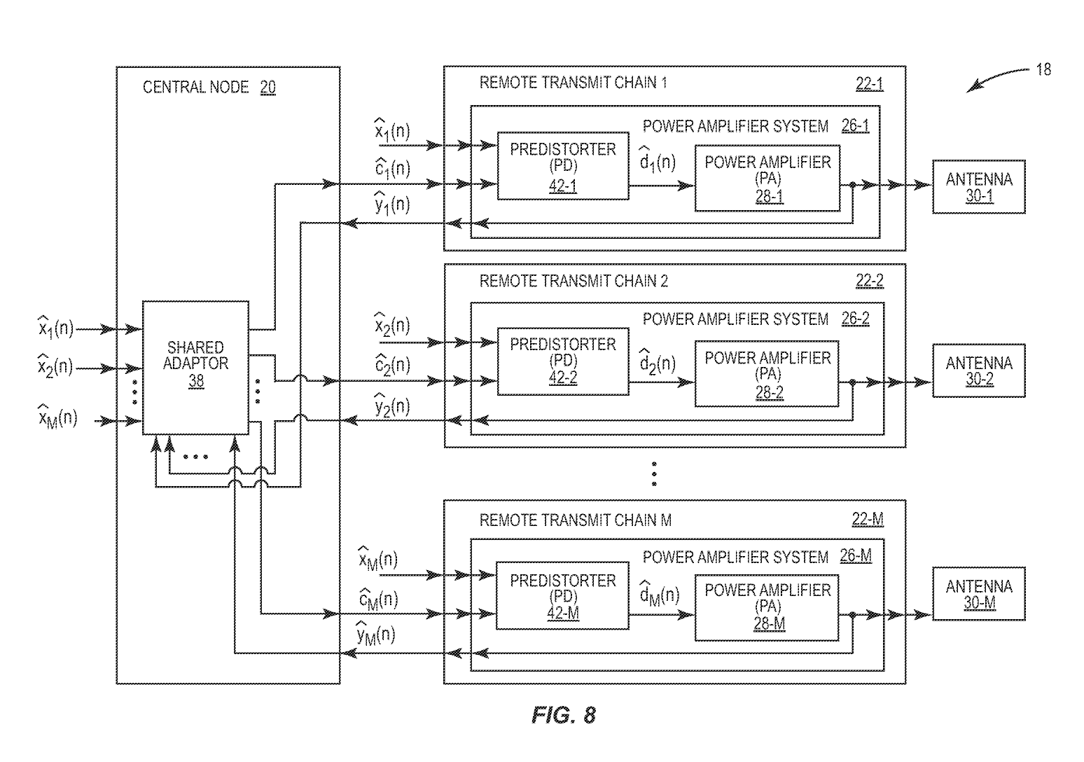

FIG. 8 is a more detailed illustration of the centralized adaptive predistortion system 18 of FIG. 2 according to a fourth embodiment of the present disclosure. This embodiment is similar to that of FIG. 7. However, in this embodiment, the one or more centralized predistortion components 24 (FIG. 2) include the shared adaptor 38 but not the shared predistorter 40 (FIG. 7). Rather, predistortion is performed by predistorters 42-1 through 42-M (generally referred to herein collectively as predistorters 42 and individually as predistorter 42) included in the remote transmit chains 22-1 through 22-M, respectively. The predistorters 42 are implemented as hardware components in the corresponding remote transmit chains 22 (e.g., microprocessors, DSP processors, ASICs, FPGAs, or similar hardware components). Note that the hardware components may, in some embodiments, be used to implement additional components of the corresponding remote transmit chains 22.

In operation, during a time-slot allocated for the i-th remote transmit chain 22-i as an example, the shared adaptor 38 evaluates the set of predistortion parameters (ĉᵢ(n)) that defines a predistortion to be applied to the data signal (\hat{x}ᵢ(n)) to be transmitted by the remote transmit chain 22-i in order to compensate for a non-linearity of the power amplifier 28-i in the remote transmit chain 22-i. As discussed above, the set of predistortion parameters (ĉᵢ(n)) is evaluated based on a comparison of a reference signal, which in this embodiment is the data signal (\hat{x}ᵢ(n)), and a feedback signal, which in this embodiment is the output signal (ŷᵢ(n)) of the power amplifier 28-i, according to a predistortion algorithm. As will be appreciated by one of ordinary skill in the art, numerous algorithms for evaluating predistortion parameters (e.g., predistortion coefficients) are well-known in the art of power amplifier linearization. Any of these predistortion algorithms may be used and the present disclosure is not limited to any particular algorithm. The central node 20 then communicates the set of predistortion parameters (ĉᵢ(n)) to the remote transmit chain 22-i via a wired or wireless connection, depending on the particular implementation.

Upon receiving the set of predistortion parameters (ĉᵢ(n)) from the central node 20, the remote transmit chain 22-i provides the set of predistortion parameters (ĉᵢ(n)) to the predistorter 42-i in the remote transmit chain 22-i. Using the set of predistortion parameters (ĉᵢ(n)), the predistorter 42-i predistorts the data signal (\hat{x}ᵢ(n)) to thereby provide the predistorted data signal (\hat{d}ᵢ(n)). The predistorted data signal (\hat{d}ᵢ(n)) is then provided to the power amplifier system 26-i for amplification by the power amplifier 28-i. The resulting output signal (ŷᵢ(n)) is provided to the antenna 30-i for transmission. It should be noted that, as will be appreciated by one having ordinary skill in the art, the remote transmit chain 22-i may include components in addition to the power amplifier system 26-i such as, for example, one or more wired or wireless communication interfaces for receiving the data signal (\hat{x}ᵢ(n)) and the set of predistortion parameters (ĉᵢ(n)) from the central node 20, an upconverter for upconverting the predistorted data signal (\hat{d}ᵢ(n)) to a desired transmit frequency, or the like. Likewise, the power amplifier system 26-i may include components in addition to the power amplifier 28-i such as, for example, power control circuitry, an impedance matching network, or the like.

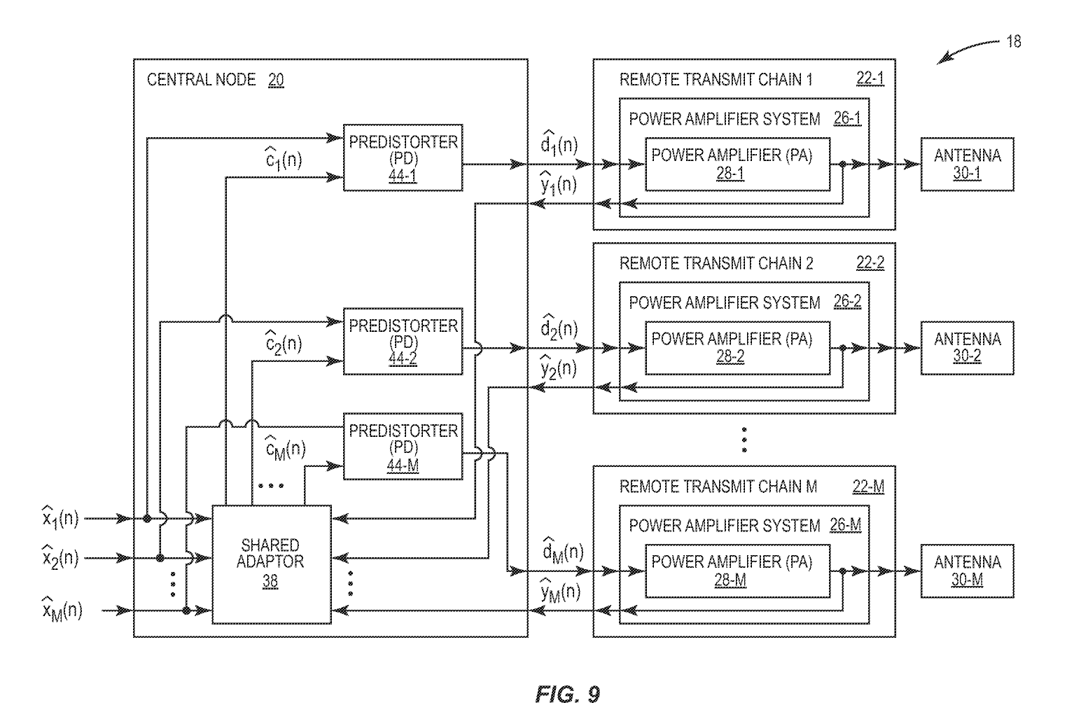

FIG. 9 is a more detailed illustration of the centralized adaptive predistortion system 18 of FIG. 2 according to a fifth embodiment of the present disclosure. This embodiment is similar to that of FIG. 7. However, in this embodiment, the one or more centralized predistortion components 24 (FIG. 2) include the shared adaptor 38 and, rather than the shared predistorter 40 (FIG. 7), individual predistorters 44-1 through 44-M (generally referred to herein collectively as individual predistorters 44 and individually as individual predistorter 44). The individual predistorters 44 are implemented as hardware components (e.g., microprocessors, DSP processors, ASICs, FPGAs, or similar hardware components).

In operation, during a time-slot allocated for the i-th remote transmit chain 22-i as an example, the shared adaptor 38 evaluates the set of predistortion parameters (ĉᵢ(n)) that defines a predistortion to be applied to the data signal (\hat{x}ᵢ(n)) to be transmitted by the remote transmit chain 22-i in order to compensate for a non-linearity of the power amplifier 28-i in the remote transmit chain 22-i. As discussed above, the set of predistortion parameters (ĉᵢ(n)) is evaluated based on a comparison of a reference signal, which in this embodiment is the data signal (\hat{x}ᵢ(n)), and a feedback signal, which in this embodiment is the output signal (ŷᵢ(n)) of the power amplifier 28-i, according to a predistortion algorithm. As will be appreciated by one of ordinary skill in the art, numerous algorithms for evaluating predistortion parameters (e.g., predistortion coefficients) are well-known in the art of power amplifier linearization. Any of these predistortion algorithms may be used and the present disclosure is not limited to any particular algorithm. Using the set of predistortion parameters (ĉᵢ(n)), the individual predistorter 44-i for the remote transmit chain 22-i predistorts the data signal (\hat{x}ᵢ(n)) to thereby provide the predistorted data signal (\hat{d}ᵢ(n)). The central node 20 then communicates the predistorted data signal (\hat{d}ᵢ(n)) to the remote transmit chain 22-i via a wired or wireless connection, depending on the particular implementation.

Upon receiving the predistorted data signal (\hat{d}ᵢ(n)) from the central node 20, the remote transmit chain 22-i provides the predistorted data signal (\hat{d}ᵢ(n)) to the power amplifier system 26-i for amplification by the power amplifier 28-i. The resulting output signal (ŷᵢ(n)) is provided to the antenna 30-i for transmission. It should be noted that, as will be appreciated by one having ordinary skill in the art, the remote transmit chain 22-i may include components in addition to the power amplifier system 26-i such as, for example, a wired or wireless communication interface for receiving the predistorted data signal (\hat{d}ᵢ(n)) from the central node 20, an upconverter for upconverting the predistorted data signal (\hat{d}ᵢ(n)) to a desired transmit frequency, or the like. Likewise, the power amplifier system 26-i may include components in addition to the power amplifier 28-i such as, for example, power control circuitry, an impedance matching network, or the like.

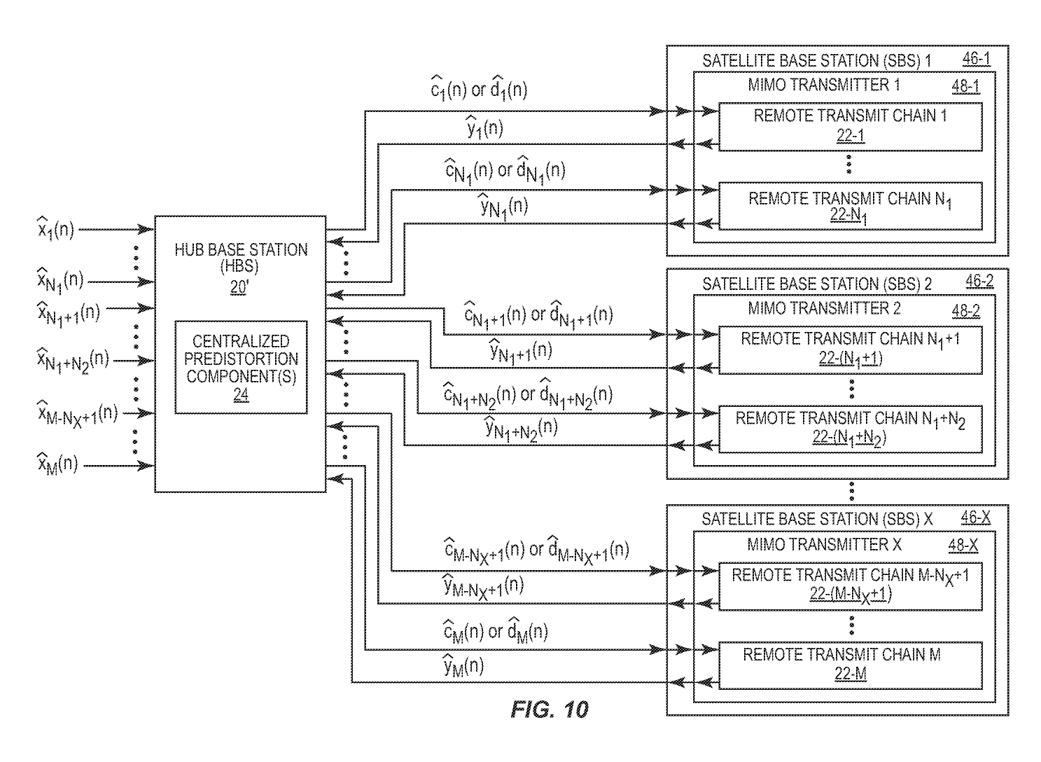

FIG. 10 illustrates one specific embodiment of the centralized adaptive predistortion system 18 wherein the central node 20 is a Hub Base Station (HBS) 20′ in a cellular network and the remote transmit chains 22-1 through 22-M are implemented in a number (X) of Satellite Base Stations (SBSs) 46-1 through 46-X (generally referred to herein collectively as SBSs 46 and individually as SBS 46). Preferably, the cellular network is an advanced cellular network such as, but not limited to, an Long Term Evolution (LTE) cellular network, an Advanced Long Term Evolution (LTE-A) cellular network, a Wideband Code Division Multiple Access (WCDMA) cellular network, a WiFi network, a WiMax network, or the like. As shown, each SBS 46 is preferably connected to only one HBS, namely the HBS 20′. The HBS 20′ is connected to multiple SBSs 46 and may, in some embodiments, operate to coordinate the transmissions of the SBSs 46. A HBS such as the HBS 20′ is a base station in a wireless communication network, a mother cell in a cellular network, a macro cell in a cellular network, a macro cell in an LTE-A network, a micro cell in a cellular network, a micro cell in an LTE-A network, or the like. An SBS such as the SBS 46 is a relay station in a cellular network, a daughter cell in a cellular network, a micro cell in a cellular network, a micro cell in an LTE-A network, a pico cell in a cellular network, a pico cell in an LTE-A network, or the like.

The SBSs 46-1 through 46-X include corresponding MIMO transmitters 48-1 through 48-X (generally referred to herein collectively as MIMO transmitters 48 and individually as MIMO transmitter 48) each including two or more of the remote transmit chains 22. Specifically, in this example, the MIMO transmitter 48-1 includes remote transmit chains 22-1 through 22-N₁, where N₁ is the number of remote transmit chains 22 in the MIMO transmitter 48-1 and is a positive integer greater than or equal to 2. The MIMO transmitter 48-2 includes remote transmit chains 22-(N₁+1) through 22-(N₁+N₂), where N₂ is the number of remote transmit chains 22 in the MIMO transmitter 48-2 and is a positive integer greater than or equal to 2. Lastly, the MIMO transmitter 48-X includes remote transmit chains 22-(M−N_{X}+1) through 22-M, where N_{X} is the number of remote transmit chains 22 in the MIMO transmitter 48-X and is a positive integer greater than or equal to 2. The operation of the centralized adaptive predistortion system 18 of FIG. 10 is the same as that discussed above with respect to FIGS. 2 through 9. As such, the details are not repeated.

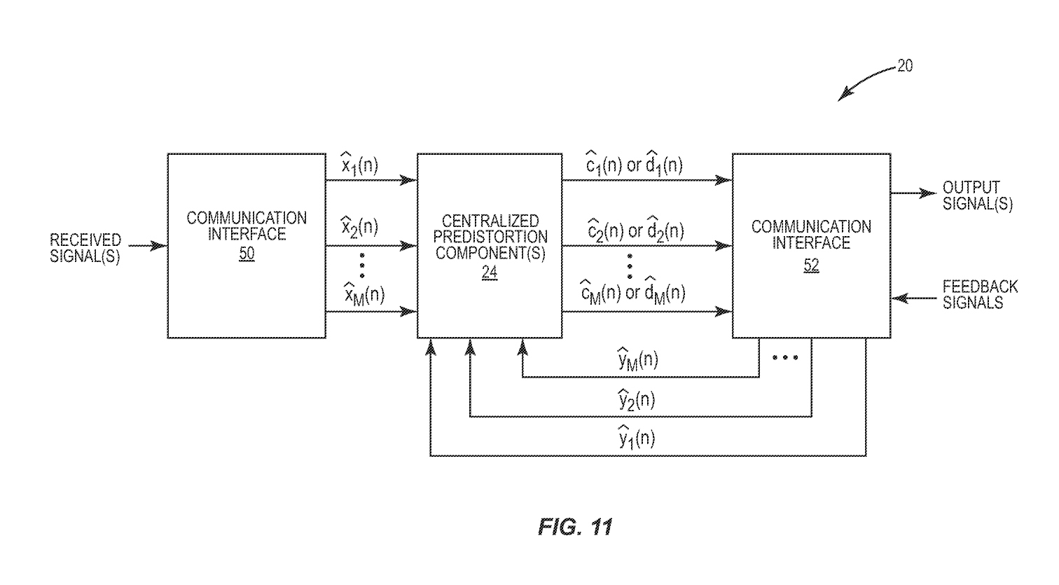

FIG. 11 is a block diagram of the central node 20 showing communication interfaces 50 and 52 by which the central node 20 sends and receives data according to one embodiment of the present disclosure. As illustrated, the communication interface 50 is either a wired or wireless communication interface by which the central node 20 receives the data signals (\hat{x}₁(n)K \hat{x}_{M}(n)) to be transmitted by the remote transmit chains 22. For example, if the central node 20 is the HBS 20′, the communication interface 50 may be a wired or wireless interface to a backhaul, or backbone, network of the cellular network or a wireless interface to another base station in the cellular network (e.g., another HBS). The communication interface 52 is either a wired or wireless communication interface by which the central node 20 sends output signals (e.g., the sets of predistortion parameters (ĉ₁(n)K ĉ_{M}(n)), the predistorted data signals (\hat{d}₁(n)K \hat{d}_{M}(n)), and/or the data signals (\hat{x}₁(n)K \hat{x}_{M}(n))) to the remote transmit chains 22 and receives the feedback signals (ŷ₁(n)K ŷ_{M}(n)) from the remote transmit chains 22. For example, if the central node 20 is the HBS 20′, the communication interface 52 is a wired or wireless interface by which the HBS 20′ communicates with the SBSs 46 (FIG. 10).

FIGS. 1 through 11 describe embodiments of a centralized architecture for power amplifier linearization. The centralized architecture offers numerous advantages over the conventional distributed architecture (i.e., architecture where each individual transmitter includes its own adaptor and predistorter). The following is a discussion of some exemplary non-limiting advantages of the centralized architecture over the conventional distributed architecture. In many cases, transmitters (e.g., transmitter(s) at SBSs) need to be designed to consume low power. However, in the conventional distributed architecture, both the adaptor and the predistorter consume power at the transmitter and therefore increase the power consumption (and limit the power efficiency) of the transmitter. Therefore, in the conventional distributed architecture, optimization of the power amplifier linearization system is a tradeoff between many conflicting factors such as: linearization algorithm complexity (the number of computations per adaptation iteration), processor speed, cost of building a processor, updating frequency (the number of iterations per unit time), computation latency (roughly equals the time required to complete one iteration), and unit/per iteration power consumption (average power consumed by the adaptor iteration). Conflicts between these factors arise in the conventional distributed architecture due to the fact that the speed of the chosen processor has to be equal to or larger than the minimum required processor speed, which is defined as: minimum required processor speed (computations/unit time)=algorithm complexity (computations/iteration) x updating frequency (number of iterations/unit time). When a processor with the minimum required processor speed is used, the processor does not have idle time and the computation latency equals the reciprocal of the updating frequency. When a processor with a processor speed that is greater than the minimum required processor speed is used, the computation latency decreases as the processor speed increases, but the processor has idle time, the percentage of which increases as the actual processor speed increases. The processor consumes power even if it is idle. Also, generally, a processor with higher processing power is more expensive to build and results in higher unit power consumption (per iteration). There are situations where the updating speed could be reduced, but the computation latency needs to be maintained at a low level. The conventional distributed architecture does not allow a cost/power efficient way to reduce updating speed while maintaining low latency.

In contrast, the centralized architecture disclosed herein moves power consumption of the adaptor and, in some embodiments, the predistorter from the transmitter to the central node 20. This is significant in that it reduces the size and power consumption of the remote transmit chains 22, which typically have low power as a high priority in their design. The centralized architecture helps to lower the constraints for its deployment, which include power supply requirements and space requirements. This benefit leads to a more flexible system and better coverage and ease of system optimization.

Also, the conflicting factors that have to be resolved in trade-offs in the conventional distributed architecture work as constructive factors in the centralized architecture. In the centralized architecture, a new dimension, a multiplexing factor, is introduced to the optimization. The multiplexing factor refers to the number of remote transmit chains 22 (and specifically the number of power amplifiers) the central node 20 serves. More specifically, with regard to processor speed, in the centralized architecture, when using a more powerful processor, the idle time of the processor can be kept at a minimum, if not zero. Therefore, no processing power is wasted. This justifies the use of powerful processors. With regard to the cost of building a processor, by selecting a more powerful processor and increasing the multiplexing factor, an increasing number of weaker processors used in the conventional distributed architecture may be replaced with a powerful processor in the centralized architecture. With respect to latency, when low latency is desired for fast adaptation, the centralized adaptive predistortion system 18 having the centralized architecture can be designed to achieve low latency without wasting processing power by increasing the multiplexing factor. With respect to updating speed, when the centralized adaptive predistortion system 18 does not require a high updating speed, the centralized architecture allows this without compromising latency by increasing the multiplexing factor. The centralized architecture also gives flexibility in deployment. Specifically, the one or more centralized predistortion components 24 may be implemented in an HBS, at a central node that is separate from the HBS, or the like. Further, the centralized architecture may be utilized with SBSs having the same or different numbers of remote transmit chains 22, with the remote transmit chains 22 having power amplifiers having equal or non-equal transmit powers, or with the remote transmit chains 22 having equal or non-equal sets of predistortion parameters or different types of predistortion parameters (e.g., 2^{nd} order polynomial predistortion coefficients, 3rd order polynomial predistortion coefficients, etc.).

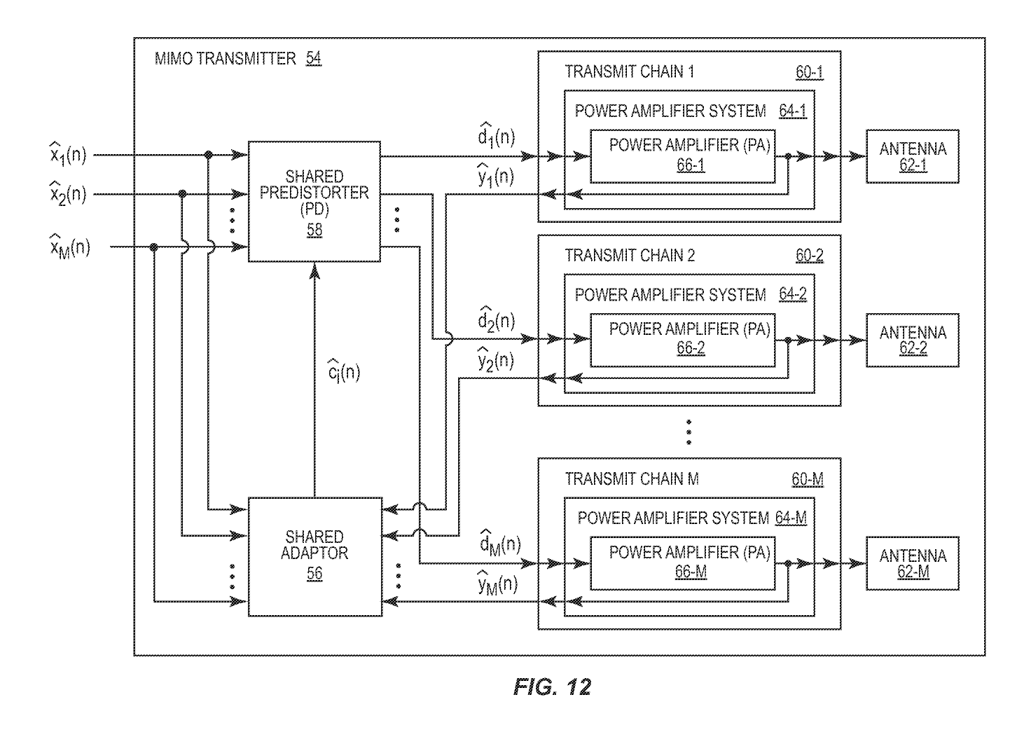

FIG. 12 illustrates a MIMO transmitter 54 including a shared adaptor 56 and a shared predistorter 58 according to one embodiment of the present disclosure. The MIMO transmitter 54 includes a number (M) of transmit chains 60-1 through 60-M (generally referred to herein collectively as transmit chains 60 and individually as transmit chain 60) connected to corresponding antennas 62-1 through 62-M (generally referred to herein collectively as antennas 62 and individually as antenna 62). The transmit chains 60-1 through 60-M include corresponding power amplifier systems 64-1 through 64-M (generally referred to herein collectively as power amplifier systems 64 and individually as power amplifier system 64) having power amplifiers 66-1 through 66-M (generally referred to herein collectively as power amplifiers 66 and individually as power amplifier 66), respectively.

The shared adaptor 56 is implemented in hardware or a combination of hardware and software. In one embodiment, the shared adaptor 56 is implemented as a microprocessor that executes corresponding software instructions, a DSP processor, an ASIC, a FPGA, or similar separate hardware component. In general, the shared adaptor 56 is time-shared by the transmit chains 60 of the MIMO transmitter 54 to evaluate sets of predistortion parameters (ĉ₁(n)K ĉ_{M}(n)) for the transmit chains 60. For each transmit chain 60, the corresponding set of predistortion parameters defines a predistortion to be applied to the data signal to be transmitted by the transmit chain 60 in order to compensate for a non-linearity of the power amplifier 66 in the transmit chain 60.

The shared predistorter 58 is implemented in hardware or a combination of hardware and software. In one embodiment, the shared predistorter 58 is implemented as a microprocessor that executes corresponding software instructions, a DSP processor, an ASIC, a FPGA, or similar separate hardware component. Note that the shared adaptor 56 and the shared predistorter 58 may be implemented as separate hardware components or a single hardware component. In general, the shared predistorter 58 is time-shared by the transmit chains 60 of the MIMO transmitter 54 to predistort the data signals (\hat{x}₁(n)K \hat{x}_{M}(n)) to be transmitted by the transmit chains 60 based on the corresponding sets of predistortion parameters (ĉ₁(n)K ĉ_{M}(n)) evaluated by the shared adaptor 56.

In operation, during a time-slot allocated for the i-th transmit chain 60-i as an example, the shared adaptor 56 evaluates the set of predistortion parameters (ĉᵢ(n)) that defines a predistortion to be applied to the data signal (\hat{x}ᵢ(n)) to be transmitted by the transmit chain 60-i in order to compensate for a non-linearity of the power amplifier 66-i in the transmit chain 60-i. The set of predistortion parameters (ĉᵢ(n)) is evaluated based on a comparison of a reference signal, which in this embodiment is the data signal (\hat{x}ᵢ(n)), and a feedback signal, which in this embodiment is the output signal (ŷᵢ(n)) of the power amplifier 66-i, according to a predistortion algorithm. As will be appreciated by one of ordinary skill in the art, numerous algorithms for evaluating predistortion parameters (e.g., predistortion coefficients) are well-known in the art of power amplifier linearization. Any of these predistortion algorithms may be used and the present disclosure is not limited to any particular algorithm.

Using the set of predistortion parameters (ĉᵢ(n)), during a time-slot allocated for the transmit chain 60-i, the shared predistorter 58 predistorts the data signal (\hat{x}ᵢ(n)) to thereby provide the predistorted data signal (\hat{d}ᵢ(n)). The predistorted data signal (\hat{d}ᵢ(n)) is provided to the power amplifier system 64-i for amplification by the power amplifier 66-i. The resulting output signal (ŷᵢ(n)) is provided to the antenna 62-i for transmission. It should be noted that, as will be appreciated by one having ordinary skill in the art, the transmit chain 60-i may include components in addition to the power amplifier system 64-i such as, for example, an upconverter for upconverting the predistorted data signal (\hat{d}ᵢ(n)) to a desired transmit frequency, or the like. Likewise, the power amplifier system 64-i may include components in addition to the power amplifier 66-i such as, for example, power control circuitry, an impedance matching network, or the like. Still further, while not shown, the MIMO transmitter 54 includes a communication interface, which may be a wired or wireless communication interface, by which the MIMO transmitter 54 receives the data signals (\hat{x}₁(n)K \hat{x}_{M}(n)).

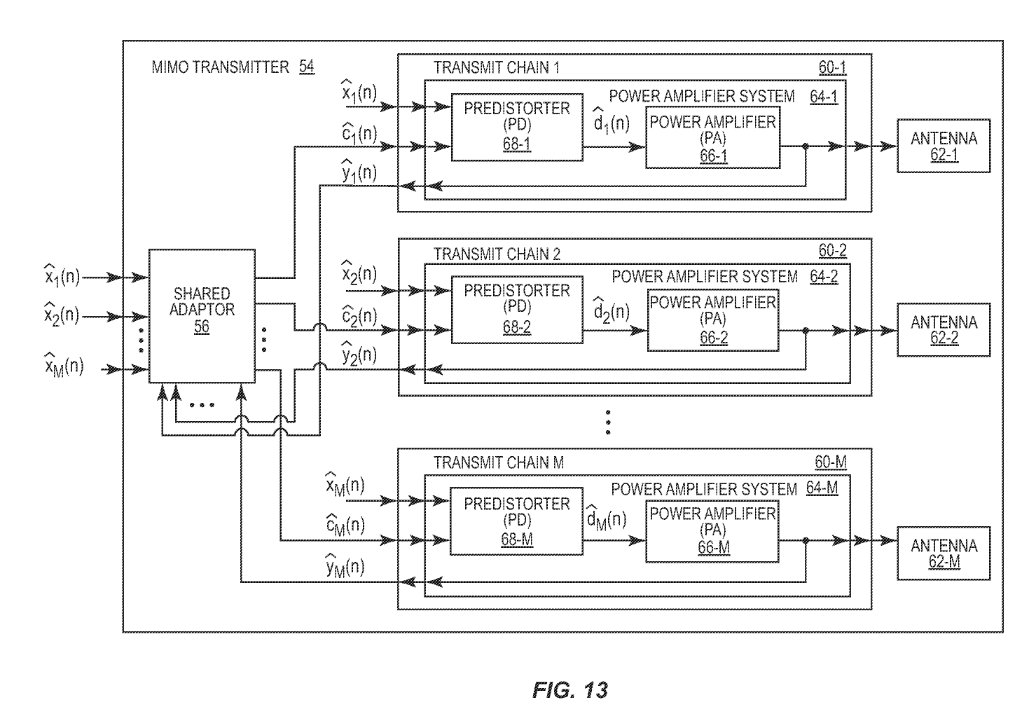

FIG. 13 illustrates the MIMO transmitter 54 according to another embodiment of the present disclosure. This embodiment is similar to that of FIG. 12. However, in this embodiment, the MIMO transmitter 54 includes the shared adaptor 56 but not the shared predistorter 58 (FIG. 12). Rather, predistortion is performed by predistorters 68-1 through 68-M (generally referred to herein collectively as predistorters 68 and individually as predistorter 68) included in the transmit chains 60-1 through 60-M, respectively. The predistorters 68 are implemented as hardware components in the corresponding transmit chains 60 (e.g., microprocessors, DSP processors, ASICs, FPGAs, or similar hardware components). Note that the hardware components may, in some embodiments, be used to implement additional components of the corresponding transmit chains 60.

In operation, during a time-slot allocated for the i-th transmit chain 60-i as an example, the shared adaptor 56 evaluates the set of predistortion parameters (ĉᵢ(n)) that defines a predistortion to be applied to the data signal (\hat{x}ᵢ(n)) to be transmitted by the transmit chain 60-i in order to compensate for a non-linearity of the power amplifier 66-i in the transmit chain 60-i. As discussed above, the set of predistortion parameters (ĉᵢ(n)) is evaluated based on a comparison of a reference signal, which in this embodiment is the data signal (\hat{x}ᵢ(n)), and a feedback signal, which in this embodiment is the output signal (ŷᵢ(n)) of the power amplifier 66-i, according to a predistortion algorithm. As will be appreciated by one of ordinary skill in the art, numerous algorithms for evaluating predistortion parameters (e.g., predistortion coefficients) are well-known in the art of power amplifier linearization. Any of these predistortion algorithms may be used and the present disclosure is not limited to any particular algorithm. The shared adaptor 56 provides the set of predistortion parameters (ĉᵢ(n)) to the predistorter 68-i in the transmit chain 60-i.

Upon receiving the set of predistortion parameters (ĉᵢ(n)), the predistorter 68-i uses the set of predistortion parameters (ĉᵢ(n)) to predistort the data signal (\hat{x}ᵢ(n)) to thereby provide the predistorted data signal (\hat{d}ᵢ(n)). The predistorted data signal (\hat{d}ᵢ(n)) is then provided to the power amplifier system 64-i for amplification by the power amplifier 66-i. The resulting output signal (ŷᵢ(n)) is provided to the antenna 62-i for transmission. It should be noted that, as will be appreciated by one having ordinary skill in the art, the transmit chain 60-i may include components in addition to the power amplifier system 64-i such as, for example, an upconverter for upconverting the predistorted data signal (\hat{d}ᵢ(n)) to a desired transmit frequency, or the like. Likewise, the power amplifier system 64-i may include components in addition to the power amplifier 66-i and the predistorter 68-i such as, for example, power control circuitry, an impedance matching network, or the like. Still further, while not shown, the MIMO transmitter 54 includes a communication interface, which may be a wired or wireless communication interface, by which the MIMO transmitter 54 receives the data signals (\hat{x}₁(n)K \hat{x}_{M}(n)).

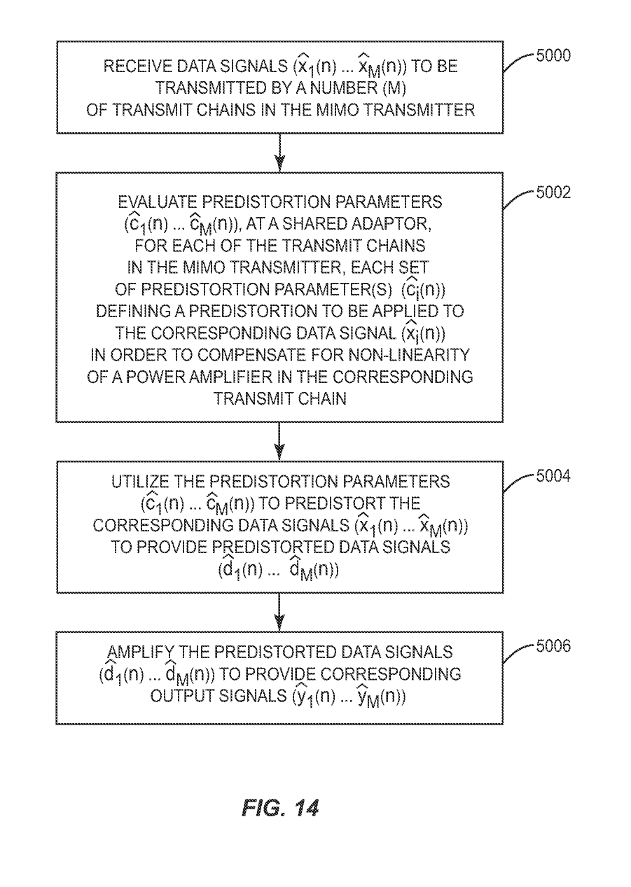

FIG. 14 is a flow chart illustrating the operation of the MIMO transmitter 54 of FIGS. 12 and 13 according to one embodiment of the present disclosure. First, the MIMO transmitter 54 receives or otherwise obtains the data signals (\hat{x}₁(n)K \hat{x}_{M}(n)) to be transmitted by the transmit chains 60 of the MIMO transmitter 54 (step 5000). Next, the shared adaptor 56 evaluates the sets of predistortion parameters (ĉ₁(n)K ĉ_{M}(n)) for the transmit chains 60 based on the corresponding data signals (\hat{x}₁(n)K \hat{x}_{M}(n)) and feedback signals (ŷ₁(n)K ŷ_{M}(n)) (step 5002). Each set of predistortion parameters (ĉᵢ(n)) defines a predistortion to be applied to the corresponding data signal (\hat{x}ᵢ(n)) in order to compensate for the non-linearity of the power amplifier 66 in the i-th transmit chain 60-i. More specifically, using the i-th transmit chain 60-i as an example, the shared adaptor 56 evaluates the set of predistortion parameters (ĉᵢ(n)) that compensates for a non-linearity of the power amplifier 66-i in the transmit chain 60-i based on a comparison of the data signal (\hat{x}ᵢ(n)) and the feedback signal (ŷᵢ(n)) for the transmit chain 60-i. Note that, as will be appreciated by one of ordinary skill in the art, gain, phase, and/or delay adjustments may be applied to the data signal (\hat{x}ᵢ(n)) and/or the feedback signal (ŷᵢ(n)) in order to obtain the actual reference and feedback signals for the comparison. Further, any suitable algorithm for adaptive predistortion power amplifier linearization may be used to evaluate the set of predistortion parameters (ĉᵢ(n)).

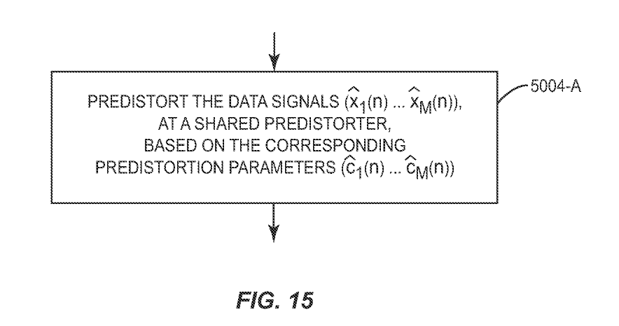

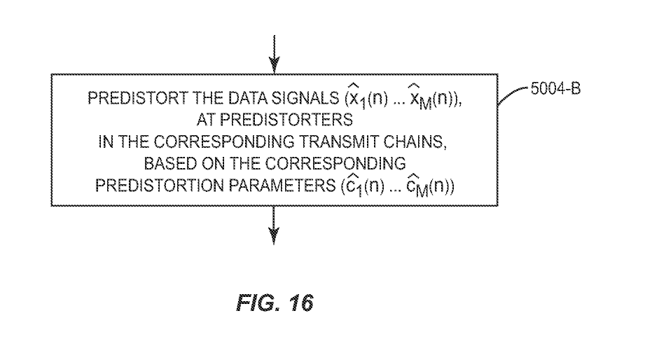

The MIMO transmitter 54 utilizes the sets of predistortion parameters (ĉ₁(n)K ĉ_{M}(n)) to predistort the corresponding data signals (\hat{x}₁(n)K \hat{x}_{M}(n)) to thereby provide the predistorted data signals (\hat{d}₁(n)K \hat{d}_{M}(n)) (step 5004). More specifically, as illustrated in FIG. 15, the shared predistorter 58 (FIG. 12) predistorts the data signals (\hat{x}₁(n)K \hat{x}_{M}(n)) based on the corresponding sets of predistortion parameters (ĉ₁(n)K ĉ_{M}(n)) to thereby provide the predistorted data signals (\hat{d}₁(n)K \hat{d}_{M}(n)) (step 5004-A). In another embodiment, as illustrated in FIG. 16, the predistorters 68 in the transmit chains 60 predistort the data signals (\hat{x}₁(n)K \hat{x}_{M}(n)) based on the corresponding sets of predistortion parameters (ĉ₁(n)K ĉ_{M}(n)) to thereby provide the predistorted data signals (\hat{d}₁(n)K \hat{d}_{M}(n)) (step 5004-B). Returning to FIG. 14, the power amplifiers 66 of the transmit chains 60 amplify the predistorted data signals (\hat{d}₁(n)K \hat{d}_{M}(n)) to provide the corresponding output signals (ŷ₁(n)K ŷ_{M}(n)) that are transmitted via the connected antennas 62 (step 5006). Notably, while steps 5000, 5004, and 5006 are performed continuously as long as there is data to be transmitted, step 5002 is preferably performed only periodically at a desired update frequency for the sets of predistortion parameters (ĉ₁(n)K ĉ_{M}(n)). However, in an alternative embodiment, step 5002 may be performed continuously as well.

Those skilled in the art will recognize improvements and modifications to the preferred embodiments of the present disclosure. All such improvements and modifications are considered within the scope of the concepts disclosed herein and the claims that follow.

What is claimed is:

1. A central node comprising:
one or more centralized predistortion components that enable predistortion of data signals to be transmitted by one or more remote transmit chains in order to compensate for non-linearity of one or more corresponding power amplifiers in the one or more remote transmit chains; and
a communication interface adapted to provide an output of the one or more centralized predistortion components to the one or more remote transmit chains.

2. The central node of claim 1 wherein the one or more remote transmit chains are a plurality of remote transmit chains.

3. The central node of claim 1 wherein:
the one or more centralized predistortion components comprise one or more individual adaptors for the one or more remote transmit chains, each individual adaptor of the one or more individual adaptors adapted to evaluate a set of predistortion parameters that define a predistortion to be applied to a data signal to be transmitted by a corresponding remote transmit chain of the one or more remote transmit chains in order to compensate for a non-linearity of the power amplifier in the corresponding remote transmit chain; and
the communication interface is adapted to, for each remote transmit chain of the one or more remote transmit chains, provide the set of predistortion parameters evaluated for the remote transmit chain to the remote transmit chain.

4. The central node of claim 3 wherein each individual adaptor of the one or more individual adaptors is further adapted to evaluate the set of predistortion parameters based on a feedback signal from an output of the power amplifier in the corresponding remote transmit chain.

5. The central node of claim 1 wherein:
the one or more centralized predistortion components comprise:
one or more individual adaptors for the one or more remote transmit chains; and
one or more individual predistorters for the one or more remote transmit chains;
wherein for each remote transmit chain of the one or more remote transmit chains:
a corresponding individual adaptor of the one or more individual adaptors is adapted to evaluate a set of predistortion parameters that define a predistortion to be applied to a data signal to be transmitted by the remote transmit chain in order to compensate for a non-linearity of the power amplifier in the remote transmit chain; and
a corresponding individual predistorter of the one or more individual predistorters is adapted to predistort the data signal to be transmitted by the remote transmit chain based on the set of predistortion parameters evaluated by the corresponding individual adaptor for the remote transmit chain to thereby provide a predistorted data signal for the remote transmit chain; and
the communication interface is adapted to, for each remote transmit chain of the one or more remote transmit chains, provide the predistorted data signal provided by the corresponding individual predistorter to the remote transmit chain.

6. The central node of claim 5 wherein for each remote transmit chain of the one or more remote transmit chains, the corresponding individual adaptor is further adapted to evaluate the set of predistortion parameters based on a feedback signal from an output of the power amplifier in the remote transmit chain.

7. The central node of claim 1 wherein the one or more remote transmit chains comprise a plurality of remote transmit chains, and:
the one or more centralized predistortion components comprise a shared adaptor for the plurality of remote transmit chains that is adapted to, for each remote transmit chain of the plurality of remote transmit chains, evaluate a set of predistortion parameters that define a predistortion to be applied to a data signal to be transmitted by the remote transmit chain in order to compensate for a non-linearity of the power amplifier in the remote transmit chain; and
the communication interface is adapted to, for each remote transmit chain of the plurality of remote transmit chains, provide the set of predistortion parameters evaluated for the remote transmit chain to the remote transmit chain.

8. The central node of claim 7 wherein the shared adaptor is time-shared by the plurality of remote transmit chains.

9. The central node of claim 7 wherein, for each remote transmit chain of the plurality of remote transmit chains, the shared adaptor is further adapted to evaluate the set of predistortion parameters based on a feedback signal from an output of the power amplifier in the remote transmit chain.

10. The central node of claim 1 wherein the one or more remote transmit chains comprise a plurality of remote transmit chains, and:
the one or more centralized predistortion components comprise:
a shared adaptor for the plurality of remote transmit chains; and
a shared predistorter for the plurality of remote transmit chains;
wherein, for each remote transmit chain of the plurality of remote transmit chains:
the shared adaptor is adapted to evaluate a set of predistortion parameters that define a predistortion to be applied to a data signal to be transmitted by the remote transmit chain in order to compensate for a non-linearity of the power amplifier in the remote transmit chain; and
the shared predistorter is adapted to predistort the data signal to be transmitted by the remote transmit chain based on the set of predistortion parameters evaluated by the shared adaptor for the remote transmit chain to thereby provide a predistorted data signal for the remote transmit chain; and
the communication interface is adapted to, for each remote transmit chain of the plurality of remote transmit chains, provide the predistorted data signal provided by the shared predistorter for the remote transmit chain to the remote transmit chain.

11. The central node of claim 10 wherein the shared adaptor and the shared predistorter are time-shared by the plurality of remote transmit chains.

12. The central node of claim 10 wherein, for each remote transmit chain of the plurality of remote transmit chains, the shared adaptor is further adapted to evaluate the set of predistortion parameters based on a feedback signal from an output of the power amplifier in the remote transmit chain.

13. The central node of claim 1 wherein the one or more remote transmit chains comprise a plurality of remote transmit chains, and:
the one or more centralized predistortion components comprise:
a shared adaptor for the plurality of remote transmit chains; and
a plurality of individual predistorters for the plurality of remote transmit chains;
wherein, for each remote transmit chain of the plurality of remote transmit chains:
the shared adaptor is adapted to evaluate a set of predistortion parameters that define a predistortion to be applied to a data signal to be transmitted by the remote transmit chain in order to compensate for a non-linearity of the power amplifier in the remote transmit chain; and
a corresponding individual predistorter of the plurality of individual predistorters is adapted to predistort the data signal to be transmitted by the remote transmit chain based on the set of predistortion parameters evaluated by the shared adaptor for the remote transmit chain to thereby provide a predistorted data signal for the remote transmit chain; and
the communication interface is adapted to, for each remote transmit chain of the plurality of remote transmit chains, provide the predistorted data signal provided by the corresponding individual predistorter to the remote transmit chain.

14. The central node of claim 13 wherein the shared adaptor is time-shared by the plurality of remote transmit chains.

15. The central node of claim 13 wherein, for each remote transmit chain of the plurality of remote transmit chains, the shared adaptor is further adapted to evaluate the set of predistortion parameters based on a feedback signal from an output of the power amplifier in the remote transmit chain.

16. The central node of claim 1 wherein the one or more centralized predistortion components result in increased power efficiency for the one or more remote transmit chains by eliminating corresponding predistortion components from the one or more remote transmit chains.

17. The central node of claim 1 wherein the central node is a hub base station and the one or more remote transmit chains are transmit chains included in one or more satellite base stations.

18. The central node of claim 1 wherein:
the central node is a hub base station selected from a group consisting of: a base station in a wireless communication network, a mother cell in a cellular network, a macro cell in a cellular network, a macro cell in an Advanced Long Term Evolution, LTE-A, network, a micro cell in a cellular network, and a micro cell in an LTE-A network; and
the one or more remote transmit chains are transmit chains included in one or more satellite base stations, each of the one or more satellite base stations selected from a group consisting of: a relay station in a cellular network, a daughter cell in a cellular network, a micro cell in a cellular network, a micro cell in an LTE-A network, a pico cell in a cellular network, and a pico cell in an LTE-A network.

19. The central node of claim 1 wherein the one or more remote transmit chains include a plurality of remote transmit chains included in one or more remote Multiple-Input-Multiple-Output, MIMO, transmitters, each including two or more of the plurality of remote transmit chains.

20. The central node of claim 1 wherein the central node is located at a first geographic location, and the one or more remote transmit chains are located at at least one second geographic location that is different from the first geographic location.

21. A method of operation of a central node associated with a cellular network comprising:
receiving one or more data signals to be transmitted by one or more remote transmit chains;
receiving feedback signals from outputs of one or more corresponding power amplifiers in the one or more remote transmit chains;
evaluating, for each remote transmit chain of the one or more remote transmit chains, a set of predistortion parameters that define a predistortion to be applied to a data signal of the one or more data signals to be transmitted by the remote transmit chain in order to compensate for a non-linearity of the power amplifier in the remote transmit chain; and
providing, for each remote transmit chain of the one or more remote transmit chains, the set of predistortion parameters evaluated for the remote transmit chain to the remote transmit chain.

22. A method of operation of a central node associated with a cellular network comprising:
receiving one or more data signals to be transmitted by one or more remote transmit chains;
receiving feedback signals from outputs of one or more corresponding power amplifiers in the one or more remote transmit chains;
evaluating, for each remote transmit chain of the one or more remote transmit chains, a set of predistortion parameters that define a predistortion to be applied to a data signal of the one or more data signals to be transmitted by the remote transmit chain in order to compensate for a non-linearity of the power amplifier in the remote transmit chain;
predistorting, for each remote transmit chain of the one or more remote transmit chains, the data signal of the one or more data signals to be transmitted by the remote transmit chain based on the set of predistortion parameters evaluated for the remote transmit chain to provide a predistorted data signal for the remote transmit chain; and
providing, for each remote transmit chain of the one or more remote transmit chains, the predistorted data signal provided for the remote transmit chain to the remote transmit chain.

23. A transmit chain comprising:
a predistorter adapted to predistort a data signal based on a set of predistortion parameters in order to compensate for a non-linearity of a power amplifier in the transmit chain to thereby provide a predistorted signal; and
a power amplifier system comprising the power amplifier adapted to amplify the predistorted signal to provide an output signal;
wherein the transmit chain receives the set of predistortion parameters from a central node that is remote from the transmit chain.

24. The transmit chain of claim 23 wherein the power amplifier system is further adapted to provide a feedback signal from an output of the power amplifier to the central node.

25. A method of operation of a transmit chain comprising:
receiving a set of predistortion parameters from a central node, wherein the set of predistortion parameters define a predistortion to be applied to a data signal to be transmitted by the transmit chain in order to compensate for a non-linearity of a power amplifier in the transmit chain;
receiving the data signal to be transmitted by the transmit chain;
predistorting the data signal based on the set of predistortion parameters to provide a predistorted data signal; and
amplifying, by the power amplifier, the predistorted data signal to provide an output signal.

26. The method of claim 25 further comprising providing a feedback signal corresponding to the output signal to the central node.

27. A transmit chain comprising:
a power amplifier system comprising a power amplifier adapted to amplify a predistorted data signal received from a central node that is remote from the transmit chain to provide an output signal;
wherein the predistorted data signal is predistorted to compensate for a non-linearity of the power amplifier.

28. The transmit chain of claim 27 wherein the power amplifier system is further adapted to provide a feedback signal from an output of the power amplifier to the central node.

29. A method of operation of a transmit chain comprising:
receiving a predistorted data signal from a central node that is remote from the transmit chain; and
amplifying, by a power amplifier in the transmit chain, the predistorted data signal to provide an output signal;
wherein the predistorted data signal is predistorted to compensate for a non-linearity of the power amplifier.

30. The method of claim 29 further comprising providing a feedback signal corresponding to the output signal to the central node.

31. A Multiple-Input-Multiple-Output, MIMO, transmitter comprising:
a plurality of transmit chains comprising corresponding power amplifiers; and
a shared adaptor adapted to, for each transmit chain of the plurality of transmit chains, evaluate a set of predistortion parameters that define a predistortion to be applied to a data signal to be transmitted by the transmit chain in order to compensate for a non-linearity of the power amplifier in the transmit chain;
wherein, for each transmit chain of the plurality of transmit chains, the set of predistortion parameters evaluated for the transmit chain are utilized to predistort the data signal to be transmitted by the transmit chain prior to amplification by the power amplifier in the transmit chain.

32. The MIMO transmitter of claim 31 further comprising a plurality of individual predistorters for the plurality of transmit chains, wherein, for each transmit chain of the plurality of transmit chains, a corresponding predistorter of the plurality of individual predistorters is adapted to predistort the data signal to be transmitted by the transmit chain based on the set of predistortion parameters evaluated by the shared adaptor for the transmit chain to thereby provide a predistorted data signal that is amplified by the power amplifier in the transmit chain.

33. The MIMO transmitter of claim 31 further comprising a shared predistorter that is adapted to, for each transmit chain of the plurality of transmit chains, predistort the data signal to be transmitted by the transmit chain based on the set of predistortion parameters evaluated by the shared adaptor for the transmit chain to thereby provide a predistorted data signal that is amplified by the power amplifier in the transmit chain.

34. The MIMO transmitter of claim 33 wherein the shared adaptor and the shared predistorter are time-shared by the plurality of transmit chains.

35. The MIMO transmitter of claim 31 wherein the shared adaptor is time-shared by the plurality of transmit chains.

36. A method of operation of a Multiple-Input-Multiple-Output, MIMO, transmitter comprising:
receiving a plurality of data signals to be transmitted by a corresponding plurality of transmit chains of the MIMO transmitter; and
for each transmit chain of the plurality of transmit chains:
evaluating, at a shared adaptor of the plurality of transmit chains, a set of predistortion parameters that define a predistortion to be applied to a data signal of the plurality of data signals that is to be transmitted by the transmit chain in order to compensate for a non-linearity of a power amplifier in the transmit chain;
utilizing the set of predistortion parameters to predistort the data signal to provide a predistorted data signal; and
amplifying, at the power amplifier in the transmit chain, the predistorted data signal to provide a corresponding output signal.

37. The method of claim 36 wherein utilizing the set of predistortion parameters to predistort the data signal comprises predistorting, at a shared predistorter of the plurality of transmit chains, the data signal based on the set of predistortion parameters to provide the predistorted data signal.

38. The method of claim 36 wherein utilizing the set of predistortion parameters to predistort the data signal comprises predistorting, at an individual predistorter of the transmit chain, the data signal based on the set of predistortion parameters to provide the predistorted data signal.
